(19) United States
(12) Patent Application Publication
(10) Pub. No.: US 2011/0037732 A1
(43) Pub. Date: Feb. 17, 2011

(54) DETECTING DEVICE, DISPLAY DEVICE, AND OBJECT PROXIMITY DISTANCE MEASURING METHOD

(75) Inventors: Daisuke Takama, Aichi (JP); Kenta Seki, Kanagawa (JP); Masato Imai, Aichi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/850,372

(22) Filed: Aug. 4, 2010

(30) Foreign Application Priority Data
Aug. 12, 2009 (JP) P2009-187134

(51) Int. Cl. G06F 3/042

(52) U.S. Cl. 345/175

(57) ABSTRACT

A detecting device includes: an optical sensor array having light reception anisotropy; a detection driving section configured to drive the optical sensor array, picking up an image of a detected object, and generate a plurality of different detection images on a basis of the light reception anisotropy; and a height detecting section configured to receive the plurality of detection images input to the height detecting section, and detect a distance (height) from a sensor light receiving surface of the optical sensor array to the detected object on a basis of magnitude of a positional displacement occurring due to difference in the light reception anisotropy in image parts corresponding to one of a shadow and a reflection of the detected object, the image parts being included in the plurality of input detection images.

### CROSS REFERENCES TO RELATED APPLICATIONS

The present application claims priority to Japanese Patent Application JP 2009-187134 filed on Aug. 12, 2009, the entire contents of which is hereby incorporated by reference.

### BACKGROUND

The present disclosure relates to a detecting device for detecting a distance (height) from the light receiving surface of an optical sensor for picking up an image of a detected object such as a finger or a stylus pen to the detected object when the detected object approaches, and a display device having a function of detecting the height. The present disclosure also relates to an object proximity distance measuring method using the light reception anisotropy of an optical sensor array.

A detecting device for detecting the contact or proximity of a detected object such as a human or a stylus pen. In addition, a display device having an optical sensor disposed therein and thereby having a contact sensor function for detecting that a detected object is in contact with or in proximity to a display surface is known.

Contact detecting systems include an optical system, a capacitance system, a resistive film system and the like. Of these systems, the optical system and the capacitance system can detect not only contact but also proximity.

A new user interface (UI) has been developed which replaces buttons and the like for operating a device by direct contact of a display screen of a display device. In particular, UIs using a display screen in mobile devices such as portable telephones have been actively developed.

A relatively small display screen as in a mobile device needs icons of a certain size when operated by a finger from a viewpoint of operability. However, when importance is attached to operability and icons are enlarged, an amount of information that can be seen at a glance is decreased.

In order to deal with such an inconvenience, a novel information display method has also been proposed which detects a finger or the like in a noncontact stage (proximity stage) and which changes a display state of video or the like displayed on a display panel according to the movement of the finger or the like (see Japanese Patent Laid-Open No. 2008-117371 (hereinafter referred to as Patent Document 1)).

The contact and proximity detecting system of a display device described in Patent Document 1 is a capacitance system, and is configured to be able to change a display state according to the proximity distance of a finger or the like. Because of this purpose, only a rough proximity distance can be detected. Specifically, in proximity detection of this display device, a change in capacitance is converted into a change in frequency, and the frequency change is converted into a voltage. It is determined that a finger effecting the change in capacitance is close when the voltage is high, and that the finger is distant when the voltage is low.

### SUMMARY

A small capacitance change in the capacitance system is buried in a noise level. When a display device includes a contact or proximity detecting function, in particular, wiring that changes in potential for display is disposed close to a detecting electrode, and the potential change in the wiring tends to be superimposed as induced noise on the detecting electrode. In addition, even when the detecting function is not of a display device built-in type, a detection signal obtained by the detection of a distance from a detected object by the capacitance system is based on a change in capacitance, so that accurate detection cannot be performed in general.

In order to be able to detect even a small capacitance change, the above-described Patent Document 1 requires that a capacitance type detector using an oscillator be prepared. This involves a disadvantage of an increase in cost of the display device (or the detecting device) described in the above-described Patent Document 1.

A detecting device and a display device, in an embodiment, can optically detect (or measure) a distance from a detected object with high accuracy while suppressing an increase in cost. In addition, the present invention provides an object proximity distance measuring method enabling high-precision detection at low cost.

A detecting device according to an embodiment includes an optical sensor array having optical anisotropy, a detection driving section for the optical sensor array, and a height detecting section.

The detection driving section drives the optical sensor array, picks up an image of a detected object, and generates a plurality of different detection images on a basis of the light reception anisotropy.

The height detecting section receives the plurality of detection images input to the height detecting section, and detects a distance (height) from a sensor light receiving surface of the optical sensor array to the detected object using the plurality of input detection images. More specifically, the height detecting section detects the height on a basis of magnitude of a positional displacement occurring due to difference in the light reception anisotropy in image parts corresponding to one of a shadow and a reflection of the detected object, the image parts being included in the plurality of detection images.

The optical sensor array itself may have the light reception anisotropy, or the light reception anisotropy may be imparted to the optical sensor array by a light reception anisotropy imparting section, for example. In the former case, for example, a thing such as eaves or the like that blocks a part of light from one side to the light receiving surface of the optical sensor array and which does not block light from another side very much may be formed integrally by a semiconductor process.

On the other hand, the detecting device in the latter case desirably has a wavelength selecting filter section for wavelength selection such as a color filter, a light shielding filter, a lens array, or the like as the light reception anisotropy imparting section.

Especially when the detecting device has a wavelength selecting filter or the like as the light reception anisotropy imparting section, the detection driving section preferably generates the plurality of detection images by a plurality of times of image pickup with light in different wavelength ranges.

The optical sensor array in this case is formed by two-dimensionally arranging a plurality of optical sensors to which the light reception anisotropy is imparted by producing wavelength dependence in amounts of received light, which is incident from different directions when the light transmitted by the light reception anisotropy imparting section is received. The detection driving section irradiates the detected object with a plurality of pieces of light respectively having different wavelength ranges from each other on a time division basis. In addition, the detection driving section controls each light reception time when reflected light reflected and returned by the detected object is received by the plurality of optical sensors after being transmitted by the light reception anisotropy imparting section in synchronism with the irradiation with the plurality of pieces of light on a time division basis. A plurality of times of image pickup are performed by the time division control, a plurality of detection images are thereby generated, and a height is detected on the basis of a displacement between the images.

As with the detecting device described above, a display device according to an embodiment includes an optical sensor array, a detection driving section, and a height detecting section. In addition, the display device includes a light modulating section and a display surface. The light modulating section modulates incident light according to an input video signal, and makes the generated display image displayed from the display surface.

An object proximity distance measuring method according to an embodiment includes the following steps.

(1) A step of driving an optical sensor array having light reception anisotropy, picking up an image of a detected object, and generating a plurality of different detection images on a basis of the light reception anisotropy.

(2) A step of measuring a distance (height) from a sensor light receiving surface of the optical sensor array to the detected object on a basis of magnitude of a positional displacement occurring due to difference in the light reception anisotropy in image parts corresponding to one of a shadow and a reflection of the detected object, the image parts being included in the plurality of detection images.

An object proximity distance measuring method according to another embodiment of the present invention includes the following steps.

(1) A step of picking up an image of a detected object a plurality of times by a combination of optical sensors corresponding to different light reception anisotropies from a plurality of optical sensors within an optical sensor array having the light reception anisotropies.

(2) A step of measuring a distance (height) from a sensor light receiving surface of the optical sensor array to the detected object on a basis of magnitude of a positional displacement occurring due to difference in the light reception anisotropies in image parts corresponding to one of a shadow and a reflection of the detected object, the image parts being included in a plurality of detection images obtained by the plurality of times of image pickup.

The present embodiments have an optical sensor array as with an ordinary optical type contact sensor. However, this optical sensor array has light reception anisotropy. Therefore height detection is possible. Thus, cost is reduced and high accuracy can be achieved as compared with the capacitance type because displacement between images is used.

Therefore, it is possible to provide a detecting device and a display device that can optically detect (or measure) a distance from a detected object with high accuracy while suppressing an increase in cost. In addition, according to the embodiments, it is possible to provide an object proximity distance measuring method enabling high-precision detection at low cost.

Additional features and advantages are described herein, and will be apparent from the following Detailed Description and the figures.

### BRIEF DESCRIPTION OF THE FIGURES

FIGS. 1A and 1B are diagrams showing principal parts of a detecting device according to a first embodiment;

FIG. 2 is a diagram showing region divisions within a light receiving surface of the detecting device;

FIGS. 3A and 3B are diagrams of assistance in explaining an example of combinations of optical sensors having different anisotropy imparting orientations in each region of FIG. 2;

FIGS. 4A1, 4A2, 4B1, and 4B2 are diagrams representing a first method of height detection;

FIGS. 5A and 5B are diagrams of assistance in explaining improvements in the first method of height detection;

FIGS. 6A and 6B are diagrams of assistance in explaining a second method of height detection;

FIG. 7 is a block diagram showing a general configuration of display devices according to a second to a fifth embodiment;

FIG. 8 is a diagram showing an example of configuration of an I/O display panel;

FIG. 9 is an equivalent circuit diagram of a display pixel section and a sensor section included in a pixel unit;

FIG. 10 is a diagram showing connecting relation between three pixels for display of three primary colors and a sensor readout H-driver;

FIGS. 11A and 11B are a plan view and a sectional view of a pixel unit of the display device according to the second embodiment;

FIG. 12 is a plan view of an arrangement of a display region and a sensor region in the display device according to the second embodiment;

FIG. 13 is a perspective view showing paths of light when a fingertip is brought into proximity to the display surface of the constitution shown in FIGS. 11A and 11B;

FIG. 14 is a timing chart showing cycles of blinking of a backlight;

FIGS. 15A, 15B1, 15B2, and 15B3 are timing charts showing respective scans for light emission, image pickup, and data writing in the second embodiment;

FIGS. 16A1, 16A2, 16B1, and 16B2 are diagrams showing a result of analysis of image pickup data in the second embodiment;

FIG. 17 is a graph showing relation between finger height and distance between peaks in detection images;

FIGS. 18A, 18B, 18C, and 18D are diagrams relating to examples of modification of the second embodiment;

FIG. 19 is a plan view and a sectional view of a pixel unit of the display device according to the third embodiment;

FIG. 20 is a plan view of an arrangement of a display region and a sensor region in the display device according to the third embodiment;

FIG. 21 is a perspective view showing paths of light when a fingertip is brought into proximity to the display surface of the constitution shown in FIG. 19;

FIGS. 22A and 22B are graphs showing the transmission spectra of an RB filter and an RGB filter;

FIGS. 23A, 23B, and 23C are graphs showing the wavelength ranges of RGB light;

FIGS. 24A1, 24A2, 24B1, and 24B2 are diagrams showing a result of analysis of image pickup data in the third embodiment;

FIGS. 25A, 25B, 25C, and 25D are diagrams relating to examples of modification of the third embodiment;

FIG. 26 is a diagram showing relation between lenses and a sensor arrangement in the display device according to the fourth embodiment;

FIGS. 27A and 27B are a sectional view and a plan view of the display device according to the fifth embodiment;

FIG. 28 is a perspective view of a television set according to a sixth embodiment;

FIGS. 29A and 29B are perspective views of a digital camera according to the sixth embodiment;

FIG. 30 is a perspective view of a notebook personal computer according to the sixth embodiment;

FIG. 31 is a perspective view of a video camera according to the sixth embodiment; and

FIGS. 32A, 32B, 32C, 32D, 32E, 32F, and 32G are opening and closing views, a plan view, a side view, a top view, and a bottom view of a portable telephone according to the sixth embodiment.

### DETAILED DESCRIPTION

Embodiments will be described with reference to the drawings by principally taking a liquid crystal display device as a display device.

Description will be made below in the following order.
1. First Embodiment: Outline of Mode for Carrying Out the Embodiment (Example of Detecting Device)
2. Second Embodiment: Application of the Embodiment to Liquid Crystal Display Device of Field Sequential System in which Light of Each Color is Applied on Time Division Basis and Image Pickup is Performed on Time Division Basis
3. Third Embodiment: Liquid Crystal Display Device of Space Division System Using Light Shielding Filter to which the Present Embodiment is Applied
4. Fourth Embodiment: Application of the Present Embodiment to Organic EL Display Device
5. Fifth Embodiment: Example of Display Device Imparting Light Reception Anisotropy Using Lens Array
6. Sixth Embodiment: Examples of Application to Electronic Devices

### 1. First Embodiment

### Configuration of Detecting Device

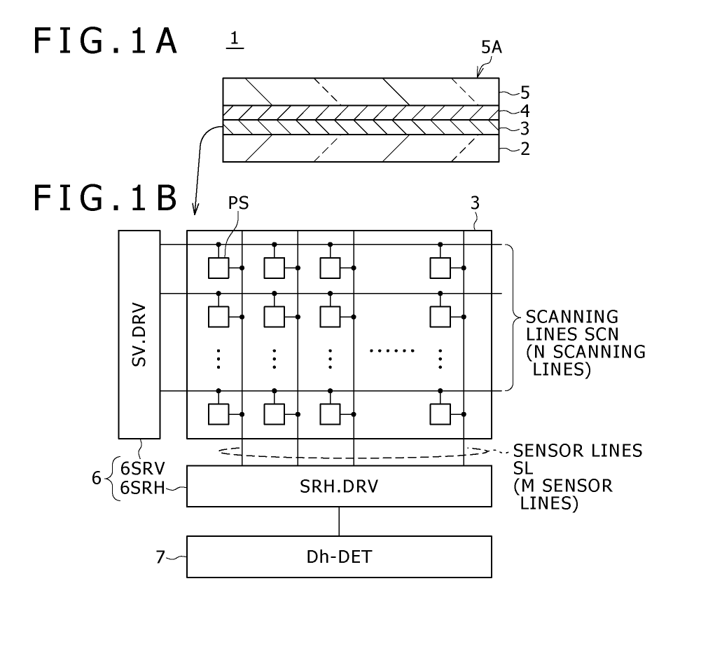

FIGS. 1A and 1B show principal parts of a detecting device according to an embodiment.

The detecting device 1 illustrated in FIG. 1A has at least a substrate 2, an optical sensor array 3, a light reception anisotropy imparting section 4, and a protective layer 5. The top surface of the protective layer 5 is a detecting surface 5A that a detected object (a finger, a stylus pen or the like) approaches.

The optical sensor array 3 in this case is formed by arranging optical sensors PS in the form of a matrix, as shown in FIG. 1B. An optical sensor PS includes a photodetector formed on the substrate by using a semiconductor process and a sensor circuit for controlling the photodetector. Details of an equivalent circuit of the optical sensor PS will be described in an embodiment to be described later.

The substrate 2 may be a semiconductor substrate. In this case, the photodetectors and the sensor circuits forming the optical sensors PS are directly formed on the substrate 2 by using a semiconductor process. The substrate 2 may be a substrate formed of an insulator. In this case, a thin film semiconductor layer is formed on the insulating substrate by using a TFT (Thin Film Transistor) forming process, and the photodetectors and the sensor circuits are formed in the thin film semiconductor layer. Further, a configuration can be adopted in which an insulating layer is formed on a semiconductor substrate and the thin film semiconductor layer is formed on the insulating layer.

In any case, optical sensor interconnecting wiring is formed in a row (horizontal) direction and a column (vertical) direction by a multilayer wiring structure for the array of the optical sensors.

The detecting device in the example shown in the figure has, as the interconnecting wiring, N scanning lines SCN for connecting optical sensors PS to each other in the horizontal direction and separating the optical sensors PS in the vertical direction and M sensor lines SL for interconnecting optical sensors PS in the vertical direction and separating the optical sensors PS in the horizontal direction.

There are a case where the thus formed optical sensor array 3 itself has light reception anisotropy and a case where light reception anisotropy is imparted to the optical sensor array 3 by disposing the light reception anisotropy imparting section 4 on the light receiving surface side of the optical sensor array 3 as shown in the figure.

“Light reception anisotropy” in this case refers to a property at a time of receiving light as if light reception sensitivity were different for light entering an optical sensor PS (light from the side of the detected object) in different directions. That is, a property of producing high sensor output for light made incident at a certain angle and producing low sensor output for light made incident at another angle is referred to as light reception anisotropy.

In the case where the optical sensor array 3 itself has light reception anisotropy, the light reception anisotropy may be imparted by a semiconductor property of the photodetector of the optical sensor PS. When this is not possible, the light reception anisotropy may be imparted to the optical sensor array 3 itself by forming a part in the form of eaves for one-side light shielding on the light receiving surface side of the optical sensor PS by a semiconductor process or the like, and thereby enhancing the light shielding property for light at a certain angle and weakening the light shielding property for light at another angle. In this case, the light reception anisotropy imparting section 4 in FIG. 1A is not necessary.

A light shielding filter imparting a similar effect to that of the part in the form of eaves as described above to the optical sensor array 3 or a color filter imparting wavelength selectivity to light at different angles is desirably used as the light reception anisotropy imparting section 4. Details of the forms and effects of the light shielding filter and the color filter will be described in an embodiment of a display device to be described later.

In addition, as will be described later in the present embodiment, a lens array in which lenses for dividing light from a detected object mainly into two directions are arranged in the form of an array can be used as the light reception anisotropy imparting section 4. Such lenses include cylindrical lenses having the shape of a semicylinder.

As shown in FIG. 1B, a vertical driving circuit (V.DRV) 6V is connected to the N scanning lines SCN, and a horizontal driving circuit (H.DRV) 6H is connected to the M sensor lines SL. In addition, a height detecting section (H.DET) 7 is connected to a sensor readout H-driver 6SRH.

A sensor readout V-driver 6SRV and the sensor readout H-driver 6SRH form a detection driving section 6. The detection driving section 6 is a circuit for driving the optical sensor array 3, picking up an image of a detected object, and generating a plurality of different detection images on the basis of light reception anisotropy. The detection driving section 6 may conceptually include a control circuit such as a CPU or the like.

The plurality of detection images are each a set of sensor outputs from the optical sensors PS, and may be analog images or digital images. Each of the plurality of detection images is image data to be supplied to the height detecting section 7 which image data is generated by converting sensor outputs discharged from the M sensor lines SL in parallel with each other into digital signals as required and accumulating the sensor outputs within the sensor readout H-driver 6SRH.

The height detecting section 7 may conceptually include a control circuit such as a CPU not shown in the figure. The height detecting section 7 is a circuit for detecting a distance (height) from the sensor light receiving surface of the optical sensor array 3 to the detected object from the plurality of detection images under control of a built-in or an external control circuit.

The height detecting section 7 itself may be a CPU. In that case, the above functions of the height detecting section 7 are implemented as a procedure of a program executed by the CPU. In addition, the height detecting section 7 may include an image memory for processing as required.

The detecting device 1 may be a detecting device of a shadow detecting type that uses external light as light for detection, or may be a display device of a reflection detecting type that has light emitted by the detecting device 1 itself reflected by the detected object.

In the case of the shadow detecting type, external light is taken in from the detecting surface 5A, and the intensity distribution of the external light is sensed by the optical sensor array 3. When there is a detected object in contact with or in proximity to the detecting surface 5A, a dark image part corresponding to the detected object is included in the intensity distribution of the external light made incident on the optical sensor array 3. The height detecting section 7 obtains the magnitude of positional displacement of the dark image part corresponding to the shadow of the object from a plurality of detection images captured with different light reception anisotropies, and detects a height from the positional displacement.

In the case of the reflection detecting type, a light irradiating section needs to be added to the constitution of FIG. 1A.

The light irradiating section is for example disposed on a rear surface side as an opposite side of the substrate 2 from the optical sensor array 3. The light irradiating section has an arbitrary light source. However, for lower power consumption and size reduction, the light irradiating section for example includes at least one LED light source and a light guiding plate for converting LED light into plane-shaped light. A reflective sheet is provided on the rear surface of the light guiding plate to increase illuminance for the optical sensor array 3.

In reflection detection, the thus generated plane-shaped light from the light irradiating section is passed through the substrate 2 formed of a transparent material such as glass, further passed through the optical sensor array 3, the light reception anisotropy imparting section 4, and the protective layer 5, and then emitted from the detecting surface 5A to the outside. The emitted light (detection light) is reflected by a detected object, and the reflected light is returned from the detecting surface 5A to the inside of the detecting device 1.

The reflected light has light reception angle dependence for imparting light reception anisotropy when passing through the light reception anisotropy imparting section 4 and is then made incident on the optical sensor array 3.

Each optical sensor PS within the optical sensor array 3 generates a plurality of or at least two different detection images based on light reception anisotropy. Principles of the optical sensor array 3 generating a plurality of different detection images are dependent on the constitution of the light reception anisotropy imparting section 4.

As will be described later, there is a case where the light reception anisotropy imparting section 4 is a light shielding filter that imparts anisotropy to light obliquely incident from one side in one direction and light obliquely incident from another side. In this case, the pattern of the light shielding filter corresponding to each optical sensor PS is determined so as to guide the two different pieces of light to the optical sensor array 3 selectively.

For example, light from a right in a horizontal direction is transmitted and light from a left in the horizontal direction is substantially blocked for alternate first light sensors arranged in the horizontal direction and a vertical direction. Conversely, light from the left in the horizontal direction is transmitted and light from the right in the horizontal direction is substantially blocked for alternate second optical sensors remaining in the horizontal direction and the vertical direction.

In this example, a first detection image is obtained from a group of discrete first optical sensors in the optical sensor array 3, and a second detection image is obtained from a group of other discrete second optical sensors in the optical sensor array 3.

An oblique light component of the reflected light when the detected object is close has a small angle of incidence (nearly perpendicular). The angle of incidence of this oblique light component is increased as the detected object goes away from the detecting surface 5A. Thus, the first and second detection images obtained by performing image pickup of the detected object as a same subject have a characteristic such that displacement of image parts corresponding to the subject (detected object) in the first and second images is increased as the subject becomes more distant.

Using this characteristic, the height detecting section 7 can accurately detect a height (distance from the sensor light receiving surface to the detected object) from the magnitude of displacement of the image parts of the detected object.

A system of imparting anisotropy spatially, as typified by the light shielding filter, will hereinafter be referred to as a space division system.

Height detection principles themselves in a case where the light reception anisotropy imparting section 4 is a color filter are the same as in the above-described case. In the case of the color filter, however, a method of imparting anisotropy is different from that of the case of the light shielding filter.

As will be described later in detail, the color filter as the light reception anisotropy imparting section 4 has a light shielding part and color filter parts of different light transmission characteristics on both sides in a direction in which anisotropy is desired to be imparted in the part corresponding to the optical sensor PS.

In this case, the detecting device 1 is limited to a reflection detecting type, and the light emitting section of the detecting device 1 needs to have a constitution that independently emits light of at least two colors of different colors. When the plurality of pieces of light (for example two pieces of light) are received by one optical sensor PS, the emission of the light is performed by time division, and control of the light receiving time of the optical sensor PS is also performed by time division synchronized with the emission of the light. Thereby image pickup by light of different colors is performed a plurality of times (for example twice), and different detection images are obtained from each image pickup.

A system of temporally controlling and imparting anisotropy, as typified by the color filter in this case, will hereinafter be referred to as a time division system.

On the other hand, it is possible to arrange a plurality of kinds of optical sensors PS in proximity to each other which optical sensors have different center wavelengths of light reception sensitivity so as to correspond to a plurality of colors, set the plurality of kinds of optical sensors PS as one set, and form the optical sensor array 3 by arranging such sets in the form of a matrix. In this case, even with a single time of image pickup, by outputting a detection image from each kind of optical sensor PS (difference in light reception sensitivity characteristic), a plurality of images in which the positions of image parts corresponding to a detected object are displaced from each other according to height can be obtained.

However, because of correspondence with the filter part of the color filter, an amount of light received by an optical sensor receiving a light component of a certain color is increased as the detected object becomes closer. Thus, the arrangement of the plurality of kinds of optical sensors needs to be determined such that an amount of light received by an optical sensor receiving a light component of another color is increased as the detected object becomes more distant.

This case is one of space division systems in a sense that anisotropy is imparted by the plurality of kinds of optical sensors PS. That is, when the color filter is used as the light reception anisotropy imparting section 4, a space division system as well as a time division system can be adopted.

This system will hereinafter be referred to as a space division system using a combination of the color filter and optical sensor characteristics to be distinguished from the space division system using the light shielding filter.

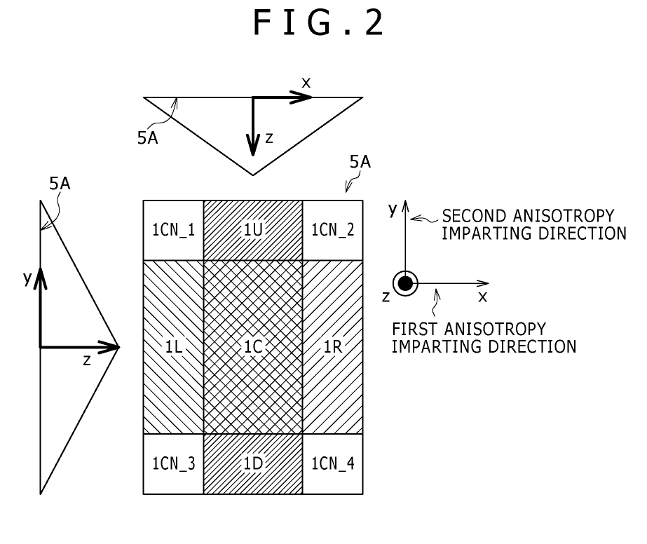

FIG. 2 shows region divisions of the detecting surface 5A of the detecting device 1 (detecting panel) which divisions are made from a viewpoint of anisotropy orientation in the light reception anisotropy imparting section 4 (the light shielding filter or the color filter). FIG. 2 shows nine in-plane regions into which the whole of the detecting surface of the detecting panel is divided. In addition, setting a direction of going away from the detecting surface 5A as a z-direction, FIG. 2 shows a detectable range in the z-direction of a detected object on an upper side and a left side of 3×3 rectangular regions (the inside of triangles is a detectable range).

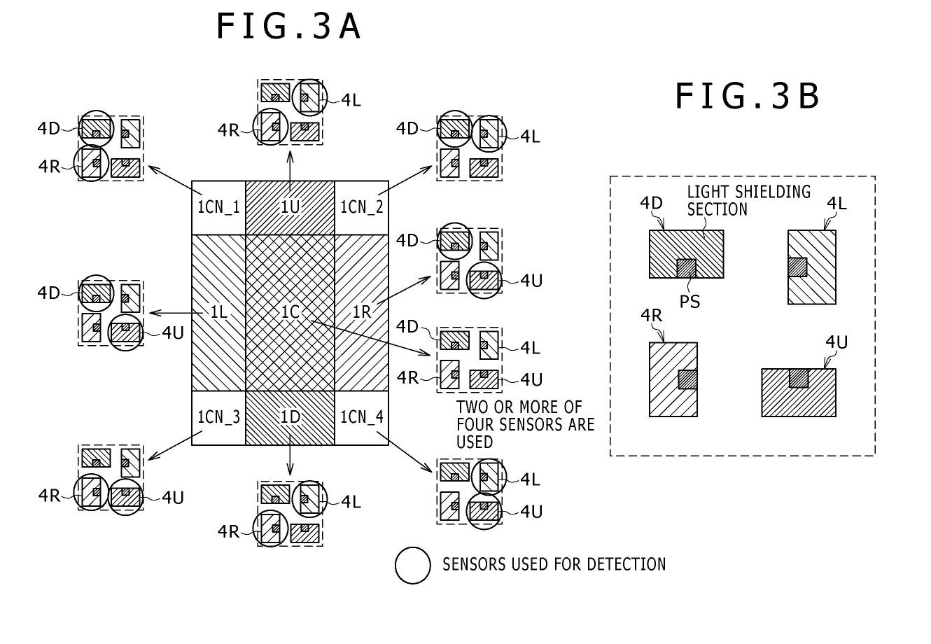

FIGS. 3A and 3B show a concrete example of sensor combinations used for height detection in each of the 3×3 rectangular regions. In this example, as shown in FIG. 3B, for example, four sensors having anisotropy imparting directions in four directions from relative positional relations between light shielding filters (light shielding sections) and optical sensors PS are set as one unit. This unit is arranged repetitively in a row direction and a column direction in the surface of the detecting device (detecting panel). The sensors in which the relative positional relations between the light shielding sections and the optical sensors PS are different are indicated by references “4D, 4L, 4R, and 4U.” Each sensor is surrounded on three sides by the light shielding section of the optical sensor PS, and light reception anisotropy is imparted in the direction of one remaining side not surrounded by the light shielding section. A downward anisotropy imparting section 4D, a left anisotropy imparting section 4L, a right anisotropy imparting section 4R, and an upward anisotropy imparting section 4U will hereinafter be used as names indicating anisotropy imparting orientations.

Incidentally, an example of imparting light reception anisotropy by relation between the light shielding sections and the optical sensors PS will be shown in the following. However, in the case of the color filter, light reception anisotropy can be imparted to one remaining side by blocking or attenuating a specific color component on three sides as in the light shielding sections.

A central square region indicated by a reference “1C” in FIG. 3A can obtain a sufficient amount of light from any direction, and thus allows two or more arbitrary combinations of the four combinations of the light shielding section and the optical sensor PS to be used in any manner.

On the other hand, regions on the right side and the left side which regions are indicated by references “1R” and “1L” in FIG. 3A preferably perform position detection in the z-direction of height from two images respectively obtained using the downward anisotropy imparting section 4D and the upward anisotropy imparting section 4U enclosed by a circle mark and given anisotropy downward and upward, for example. The upward and downward anisotropies are desirably used because amounts of light incident on the left and right regions from the left and the right are not equal to each other but amounts of light incident on the left and right regions from the upward direction and the downward direction are substantially equal to each other.

Regions on the upper side and the lower side which regions are indicated by references “1U” and “1D” in FIG. 3A preferably perform position detection in the z-direction of height from two images respectively obtained using the left anisotropy imparting section 4L and the right anisotropy imparting section 4R enclosed by a circle mark and given anisotropy to the right and the left, for example. The left and right anisotropies are desirably used because amounts of light incident on the top and bottom regions from the upward direction and the downward direction are not equal to each other but amounts of light incident on the top and bottom regions from the left and the right are substantially equal to each other.

On the other hand, regions as four corner parts shown in FIG. 3A have different combinations of anisotropy imparting sections desirably used according to the respective positions of the regions.

The region as the upper left corner part indicated by a reference “1CN_1” has limited amounts of incident light from the top and the left, and thus preferably uses the downward anisotropy imparting section 4D and the right anisotropy imparting section 4R. For similar reasons, the region as the upper right corner part indicated by a reference “1CN_2” uses the downward anisotropy imparting section 4D and the left anisotropy imparting section 4L. In addition, the region as the lower left corner part indicated by a reference “1CN_3” uses the right anisotropy imparting section 4R and the upward anisotropy imparting section 4U. Further, the region as the lower right corner part indicated by a reference “1CN_4” uses the left anisotropy imparting section 4L and the upward anisotropy imparting section 4U.

By thus selecting combinations of appropriate anisotropy imparting sections according to the positions of the detecting surface 5A, position detection in the z-direction of height can be performed from two images obtained from respective anisotropy imparting sections. That is, when anisotropy imparting sections as enclosed by circle marks in FIG. 3A are selected, an image positional displacement in the x-direction or the y-direction occurs between two images obtained from respective anisotropy imparting sections. The height detecting section 7 in FIG. 1B performs position detection to determine the height (z-direction) of the detected object on the basis of the magnitude of the positional displacement.

Incidentally, when the light shielding sections shown in FIGS. 3A and 3B are replaced by the blocking or transmission of a specific color by a color filter, image obtainment combining time division and space division is possible.

In the case of the color filter, two color filter sections selecting different wavelength ranges, that is, provided with color selectivity are disposed as two arbitrary anisotropy imparting sections (two appropriate anisotropy imparting sections in circle marks according to the regions in FIG. 3A) of the right anisotropy imparting section 4R, the left anisotropy imparting section 4L, the downward anisotropy imparting section 4D, and the upward anisotropy imparting section 4U.

[Height Detecting Method]

Description will next be made of two examples of a height detecting method performed by the height detecting section 7 using two detection images. Incidentally, while a combination of the right anisotropy imparting section 4R and the left anisotropy imparting section 4L is used as an example in the following description, a combination of the downward anisotropy imparting section 4D and the upward anisotropy imparting section 4U may be used according to a detecting position, as described above. In addition, one of the upward and downward anisotropy imparting sections and one of the left and right anisotropy imparting sections may be combined with each other arbitrarily according to a position such as a corner part.

A first method uses two detection images output from the detection driving section 6 in FIG. 1B, and detects a height on the basis of a peak position of a sensor output distribution of an image part corresponding to a detected object which image part is included in each of the two detection images.

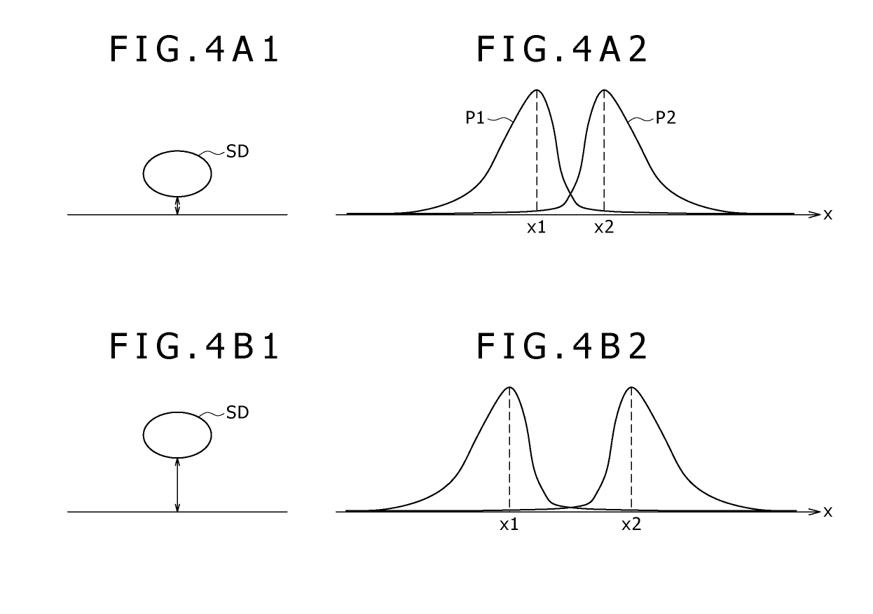

FIGS. 4A2 and 4B2 are diagrams of assistance in explaining the first method.

In FIGS. 4A2 and 4B2, an axis of abscissas indicates position in an anisotropy imparting direction (for example the x-direction), and sensor output (amount of received light) producing an image part corresponding to a detected object is increased with increasing distance in a vertical direction from the axis of abscissas. That is, the axis of ordinates indicates the line profiles of detection images. FIGS. 4A1 and 4B1 schematically show differences in distance of a detected object SD from a reference surface (for example the detecting surface 5A or the light receiving surface) when the line profiles of detection images in FIGS. 4A2 and 4B2, respectively, are obtained.

As shown in FIGS. 4B1 and 4B2, the line profile of a first detection image (hereinafter a first detection image P1) is obtained from a right anisotropy sensor receiving light transmitted by the right anisotropy imparting section 4R (see FIG. 2), and the peak of the line profile of the first detection image has a relatively small x-direction address. On the other hand, the line profile of a second detection image (hereinafter a second detection image P2) is obtained from a left anisotropy sensor receiving light transmitted by the left anisotropy imparting section 4L (see FIG. 2), and the peak of the line profile of the second detection image has a relatively large x-direction address. An X-coordinate difference between the peaks of the first and second detection images changes according to the magnitude of the position of the detected object SD from the reference surface.

When the detected object SD is relatively small, the peak of each output distribution is determined uniquely, and thus the peak coordinate x1 of the first detection image P1 and the peak coordinate x2 of the second detection image P2 can be determined. The height detecting section 7 calculates a difference between the peak coordinates (x2−x1), and determines the height of the detected object SD from the magnitude of the difference.

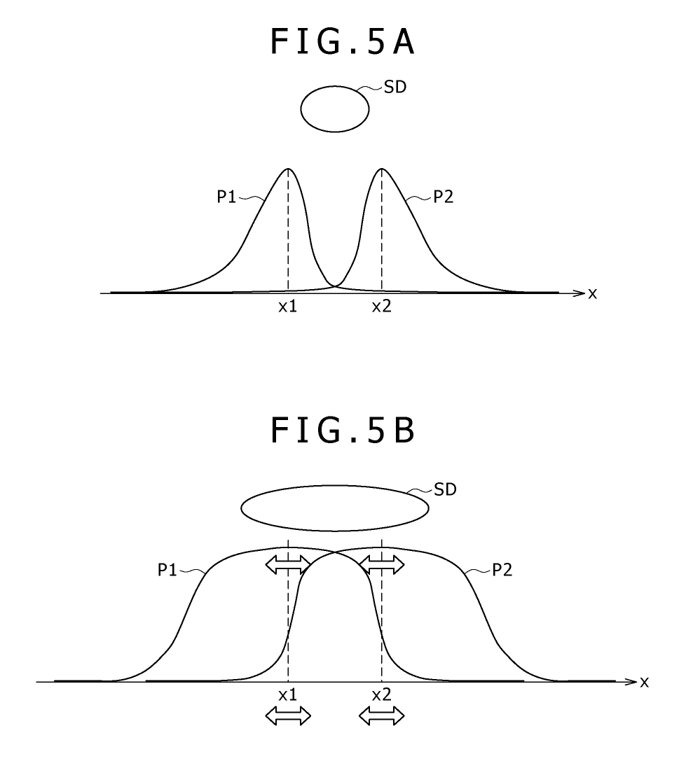

FIGS. 5A and 5B show a difference in detection image profile according to the size of the detected object SD.

FIG. 5A represents a case of a small detected object SD, whereas FIG. 5B represents a case of a large detected object SD.

The foregoing first method described above with reference to FIGS. 4A1 to 4B2 is performed well in a case of a small object such as a fingertip. However, at the time of a large object, the peak detecting method is not able to determine a distance (height) from the sensor light receiving surface to the object accurately. This is because the respective line profiles of the first detection image P1 and the second detection image P2 may be flat around peaks thereof in the case of a large object (detected object SD) and the detected peaks range widely depending on accuracy of peak detection in that case. Thus, an amount of positional displacement also includes an error depending on which point in the detected peak range is set as an object for difference calculation. As a result, the height detection may have poor accuracy.

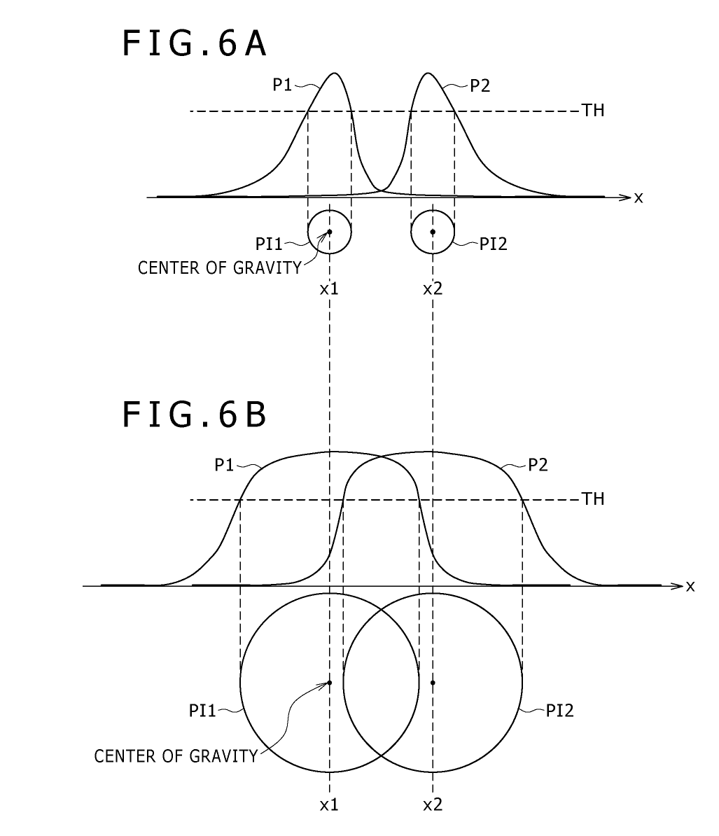

FIGS. 6A and 6B represent a second method.

The second method is free from the disadvantages of the first method. FIG. 6A shows an example of a sensor output distribution in a case of a small detected object. FIG. 6B shows an example of a sensor output distribution in a case of a large detected object.

The second method binarizes each piece of detection image data using a certain threshold value TH common to a first detection image P1 and a second detection image P2, and performs height detection on the basis of the binarized information. The binarized information is represented by two circle marks in FIGS. 6A and 6B. A first identifying image PI1 obtained by converting the first detection image P1 and a second identifying image PI2 obtained by converting the second detection image P2 respectively correspond to detection image parts corresponding to the detected object. Thus, the identifying images in FIG. 6B are large as compared with FIG. 6A. Although the size (diameter) of the identifying images depends on a method of determining the threshold value TH, the size itself does not affect the height detection.

In the height detection, the respective barycentric positions in the x-direction of the first identifying image PI1 and the second identifying image PI2 obtained by the height detecting section 7 are determined. A method of averaging addresses of both ends in the x-direction, for example, can be adopted as a method of determining the barycentric positions.

The two barycentric positions thus obtained are constant irrespective of the size of the detected object as long as the detected object is at the same position with respect to the detecting surface 5A. Specifically, the barycentric position of the first identifying image PI1 obtained in FIG. 6A and the barycentric position of the second identifying image PI2 obtained in FIG. 6B coincide with each other on an x-axis. In addition, the barycentric positions do not change even when the threshold value TH is changed (in a case of symmetric distributions). On the other hand, while there may be a case of nonsymmetric distribution as in a case of a finger being in proximity obliquely, the barycentric positions do not differ greatly with the same threshold value TH.

Incidentally, in the second method, peaks of distributions are lowered when the detected object is at a distant position, and the peaks may be below the threshold value TH. The second method is beset with the inconvenience of a need to change the threshold value TH in that case.

Thus, for example, supposing that the first method is used for low distribution peaks and detection of small detected objects and that the second method is used for high distribution peaks and detection of large detected objects, switching between the first method and the second method can be made, or the first method and the second method can be used in combination with each other.

The detecting device 1 according to the present embodiment capable of the above-described height detection performs optical detection and height detection based on image processing calculation. Thus, even when noise is superimposed on sensor output, the noise is cancelled at the time of the difference calculation. Therefore the height detection can be performed with high accuracy. In addition, while the light reception anisotropy imparting section 4 may be necessary, a large-scale circuit for converting sensor output using an oscillator and the like is not necessary, which is advantageous in terms of cost.

The second method can also detect the size of the detected object using the binarized information as it is. Incidentally, when the size of the detected object is desired to be detected in a planar form, size detection in the first anisotropy imparting direction and size detection in the second anisotropy imparting direction in FIG. 2 are necessary.

### 2. Second Embodiment

A display device according to a second embodiment may be realized as a display panel (I/O display panel) capable of interactive information input and output with a user. Alternatively, the display device according to the present embodiment may be realized as a display module obtained by module implementation of the I/O display panel and an IC external to the I/O display panel, and for example a television receiver or a monitoring device including an application program executing section as well.

Details of the second embodiment will be described in the following by taking as an example a display device including an application program executing section as well.

[General Configuration of Display Device]

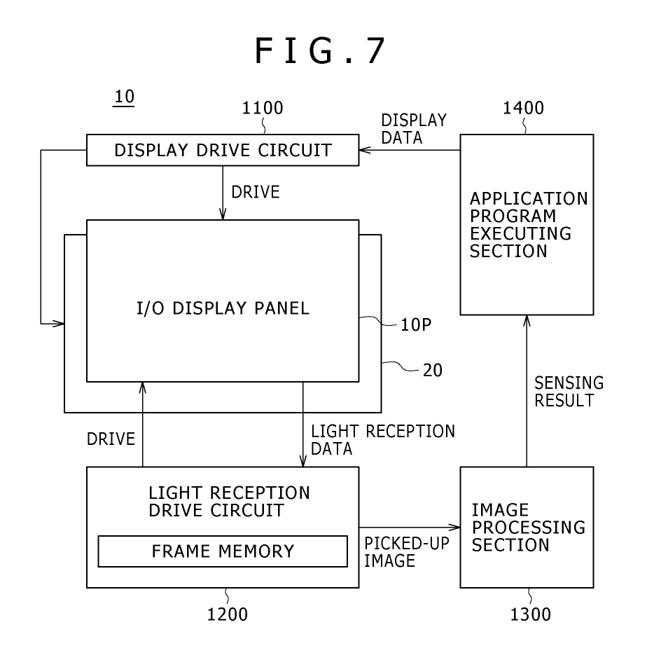

FIG. 7 is a block diagram showing a general configuration of the display device.

The display device 10 illustrated in FIG. 7 has an I/O display panel 10P, a backlight 20, a display drive circuit 1100, a light reception drive circuit 1200, an image processing section 1300, and an application program executing section 1400.

The I/O display panel 10P is formed by a liquid crystal panel (LCD (Liquid Crystal Display)) having a plurality of pixels arranged in the form of a matrix over an entire surface. The I/O display panel 10P has a function (display function) of displaying images such as predetermined graphics and characters based on display data while performing line-sequential operation. In addition, as will be described later, the I/O display panel 10P has a function (image pickup function) of picking up an image of an object in contact with or in proximity to a display surface 11 of the I/O display panel 10P.

The backlight 20 is a light source of the I/O display panel 10P which light source is formed by arranging a plurality of light emitting diodes (LEDs) emitting three primary colors, for example. As will be described later, the backlight 20 performs an operation of turning on or off the LEDs of each color at high speed in predetermined timing synchronized with the operation timing of the I/O display panel 10P under control of the display drive circuit 1100.

The display drive circuit 1100 drives the I/O display panel 10P (performs driving for line-sequential operation) so that an image based on display data is displayed on the I/O display panel 10P.

The light reception drive circuit 1200 picks up an image of a detected object such as a fingertip and outputs the picked-up image as a plurality of detection images so that received light data is obtained in the I/O display panel 10P.

Whereas the display drive circuit 1100 drives a liquid crystal layer (light modulating layer) by performing pixel driving on a line-sequential basis, the light reception drive circuit 1200 drives an optical sensor array on a line-sequential basis. Incidentally, the received light data from optical sensors is accumulated in a frame memory (FM) in a frame unit, for example, and is output as picked-up image (plurality of detection images) to the image processing section 1300.

The image processing section 1300 performs predetermined image processing (arithmetic processing) on the basis of the picked-up image (detection images) output from the light reception drive circuit 1200. The image processing section 1300 thereby detects and obtains information on the object in contact with or in proximity to the I/O display panel 10P (position coordinate data, data on the shape and size of the object, and the like). Incidentally, a process of detecting a distance (height) in the z-direction, in particular, in the sensing process has already been described with reference to FIGS. 4A1 to 6B in the first embodiment, and therefore description thereof will be omitted in the following.

The application program executing section 1400 is a circuit for performing processing according to predetermined application software on the basis of a result of the sensing by the image processing section 1300.

A process of making a display button larger or smaller according to a result of height detection, a process of changing the button itself, and the like exemplify the processing according to the application software.

In addition, high-precision height detection can be performed by applying an embodiment of the present invention. It is thus possible to divide a range of height into a few steps, and input multilevel information having an amount of information more than binary information for a simple button change or the like to the application software according to a division in which a detected object such as a fingertip is present. Thus, the present invention is also applicable to operations of application software in which a degree of operation, for example a degree of action in a game is controlled by the height of a fingertip.

Incidentally, a process of including position coordinates (including height) of a detected object such as a fingertip in display data and displaying the position coordinates on the I/O display panel 10P can also be illustrated as a simple example.

The display data generated by the application program executing section 1400 which display data includes button display and position data or the like is supplied to the display drive circuit 1100.

[General Configuration of Display Panel]

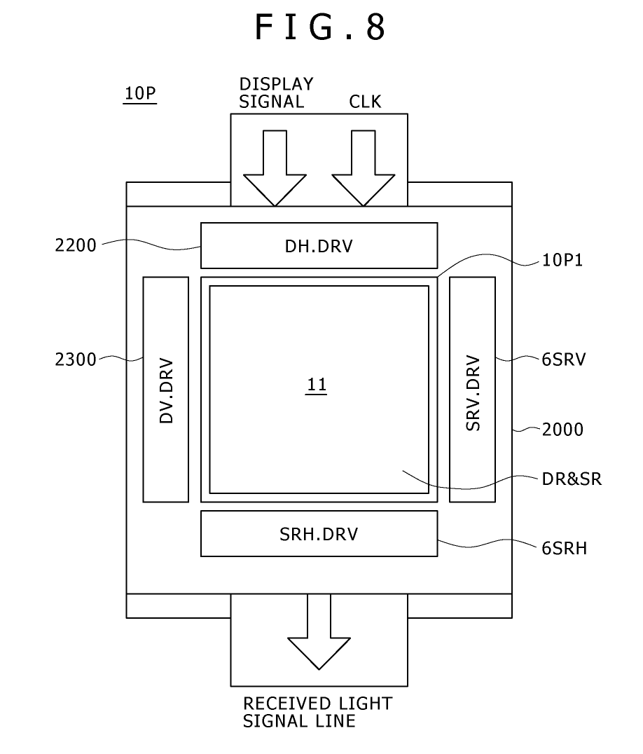

FIG. 8 is a diagram showing an example of configuration of the I/O display panel 10P.

The I/O display panel 10P illustrated in FIG. 8 has a display section 10P1 including a display region DR and a sensor region SR, a display H-driver (DH.DRV) 2200, and a display V-driver (DV.DRV) 2300. The I/O display panel 10P also has a sensor readout H-driver (SRH.DRV) 6SRH and a sensor readout V-driver (SV.DRV) 6SRV.

The display region DR and the sensor region SR are a region for modulating light from the backlight 20 and emitting display light, and picking up an image of an object in contact with or in proximity to the display surface 11 of the I/O display panel 10P. For this, liquid crystal elements including a light modulating layer and light receiving elements (optical sensors PS) are arranged in the form of a matrix in the display region DR and the sensor region SR, respectively.

The display H-driver 2200 and the display V-driver 2300 are a circuit for performing line-sequential driving of the liquid crystal elements of the respective pixels within the display section 10P1 on the basis of a display signal for display driving and a control clock (CLK) supplied from the display drive circuit 1100 (FIG. 7).

The sensor readout V-driver 6SRV and the sensor readout H-driver 6SRH are a circuit for performing line-sequential driving of the light receiving elements (optical sensors PS) of the respective pixels within a sensor area 2100 and obtaining a sensor output signal.

A detection driving section in the display device 10 according to the second embodiment includes not only the sensor readout V-driver 6SRV and the sensor readout H-driver 6SRH for controlling image pickup but also the display drive circuit 1100 in FIG. 7. The detection driving section thereby has a function of controlling the backlight 20 in synchronism with image pickup.

[Circuit Configuration of Pixel Unit]

A pixel unit is a set of pixels forming a basis for color arrangement of three colors, four colors or the like, and the display region DR and the sensor region SR are formed by arranging pixel units regularly.

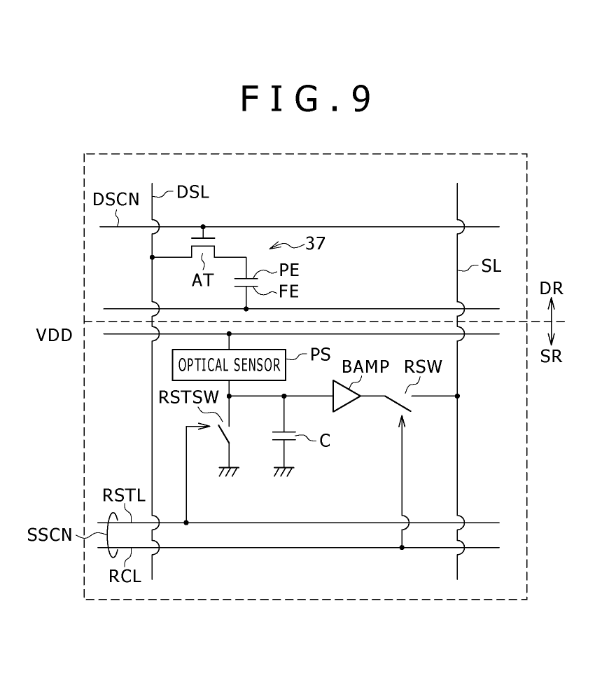

FIG. 9 is an equivalent circuit diagram of a display pixel section and a sensor section included in a pixel unit. The sensor section is generally disposed at a boundary between pixel units using a light shielding region provided between display pixel sections. Thus, a region in which the display pixel section is disposed will hereinafter be referred to as a “display region DR,” and the sensor section will hereinafter be referred to as a “light shielding region” or a “sensor region.” The light shielding region and the sensor region will be denoted by the same reference “SR.” The display region DR and the sensor region (light shielding region) SR are regularly arranged repetitively in the display section 10P1 in FIG. 8.

The display region DR has an access transistor AT formed by a thin film transistor (TFT) or the like in the vicinity of an intersection of a display scanning line DSCN extending in a horizontal direction and a display signal line DSL extending in a vertical direction. When the access transistor AT is formed by a FET, the gate of the access transistor AT is connected to the display scanning line DSCN, and the drain of the access transistor AT is connected to the display signal line DSL. The source of the access transistor AT is connected to a pixel electrode PE of each pixel. The pixel electrode PE drives an adjacent liquid crystal layer (light modulating layer) 37. The pixel electrode PE is generally formed of a transparent electrode material.

A counter electrode FE opposed to the pixel electrode PE with the liquid crystal layer interposed between the counter electrode FE and the pixel electrode PE is provided to a common potential line extending in a direction orthogonal to the display signal line DSL (horizontal direction). The counter electrode FE is generally provided so as to be common to pixels and formed of a transparent electrode material.

Each pixel in the display region DR of such a configuration turns on or off the access transistor AT on the basis of a display scanning signal supplied via the display scanning line DSCN. When the access transistor AT is turned on, a pixel voltage corresponding to a display signal supplied to the display signal line DSL at this time is applied to the pixel electrode PE. Thereby a display state is set.

An optical sensor PS formed by a photodiode, for example, is disposed in the sensor region (light shielding region) SR adjacent to the display region DR. A power supply voltage VDD is supplied to the cathode side of the optical sensor PS because of a reverse bias. The anode side of the optical sensor PS is connected with a reset switch RSTSW and a capacitor C.

The anode of the optical sensor PS has a storage capacity determined by the size of the capacitor C. A charge stored by the capacitor C is discharged (reset) to a ground potential by the reset switch RSTSW. A time from changing the reset switch RSTSW from an on state to an off state to next turning on the reset switch RSTSW corresponds to a charge accumulating time, that is, an image pickup time.

In addition, a buffer amplifier BAMP and a readout switch RSW are connected in series with each other between the anode of the optical sensor PS and a sensor line SL extending in the vertical direction.

An accumulated charge is supplied to the sensor line SL via the buffer amplifier BAMP in timing in which the readout switch RSW is turned on, and then output to the outside of a basic configuration 3100 of the pixel unit shown in FIG. 9. Operations of turning on and off the reset switch RSTSW are controlled by a reset signal supplied by a reset line RSTL, and operations of turning on and off the readout switch RSW are controlled by a read control signal supplied by a read control line RCL. The reset line RSTL and the read control line RCL form a sensor scanning signal line SSCN.

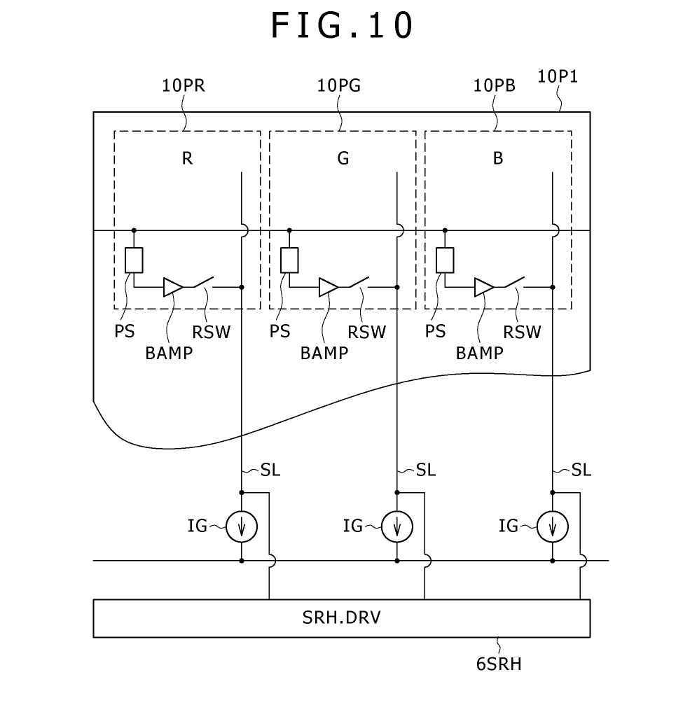

FIG. 10 shows connecting relation between three pixels for display of three primary colors and the sensor readout H-driver 6SRH.

In FIG. 10, a basic configuration 10PR of a pixel unit including a pixel (R-pixel) at a time of red (R) display, a basic configuration 10PG of a pixel unit including a pixel (G-pixel) at a time of green (G) display, and a basic configuration 10PB of a pixel unit including a pixel (B-pixel) at a time of blue (B) display are shown arranged side by side within the display section 10P1. Incidentally, while the colors of the pixels are defined by the color arrangement of a color filter in other embodiments, the colors of the pixels are defined by the colors of the LED light source in the present embodiment because of a field sequential system. Thus, the basic configurations 10PR, 10PG, and 10PB of the three pixel units shown in FIG. 10 represent an identical pixel unit that changes in display color in time series.

A charge accumulated in a capacitor (not shown) connected to an optical sensor PS in the basic configuration of each pixel unit and a parasitic capacitance is amplified by a buffer amplifier BAMP. The charge after being amplified is supplied to the sensor readout H-driver 6SRH via a sensor line SL in timing in which a readout switch RSW is turned on.

Incidentally, a constant-current source IG is connected to the sensor line SL, so that the sensor readout H-driver 6SRH detects a signal corresponding to an amount of received light with good sensitivity.

[Plane and Sectional Structure of Pixel Unit]

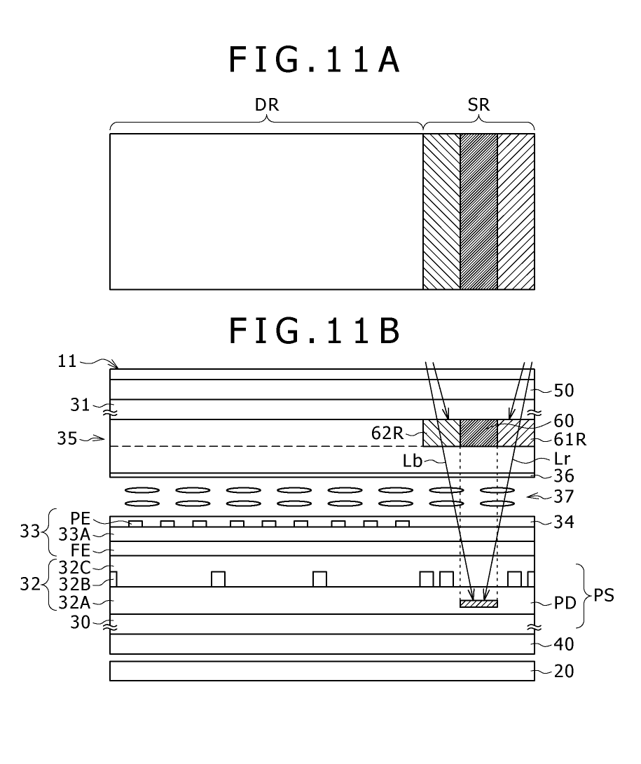

FIG. 11A shows a plane surface of a pixel unit (region division of the light reception anisotropy imparting section 4 (see FIG. 1A)). FIG. 11B shows a section of the pixel unit so as to correspond to FIG. 11A.

A (liquid crystal) display device 10 illustrated in FIG. 11B has a backlight 20 disposed on a back (surface on a lowermost layer in the figure) side as an opposite side from a display surface 11 (surface on an uppermost layer side in the figure).

The (liquid crystal) display device 10 has two glass substrates laminated to each other, has various functional layers between the two glass substrates and on an external surface side, and has a display section 10P1 disposed between the backlight 20 and the display surface 11. The display section 10P1 in this case corresponds to an effective display region of the I/O display panel 10P in FIG. 7.

Though not shown in detail, the backlight 20 is an illuminating device dedicated to an image display, which illuminating device is formed by integrally assembling a light guiding plate, a light source such as an LED, a light source driving section, a reflective sheet, a prism sheet and the like.

The display section 10P1 has a TFT substrate 30 on the side of the backlight 20 and a counter substrate 31 on the side of the display surface 11 as the two glass substrates described above.

A light receiving layer 32 composed of an insulating film 32A, a wiring layer 32B, and a planarizing film 32C is formed on a principal surface of the optical pickup unit 30 on the side of the display surface 11. In addition, a first polarizing plate 40 is laminated to another principal surface (back surface) of the TFT substrate 30.

A photodiode PD of an optical sensor PS is formed in the insulating film 32A within the light receiving layer 32. An upper surface (surface on the side of the display surface 11) of the photodiode PD is a sensor light receiving surface.

A large number of pieces of wiring constituting the sensor line SL, the reset line RSTL, the read control line RCL, a power supply line and the like in FIG. 9 is formed in the wiring layer 32B having an opening above the photodiode PD.

The planarizing film 32C is formed covering the wiring so as to planarize level differences due to the wiring.

A display electrode layer 33 including a counter electrode FE (referred to also as a common electrode), an insulating film 33A, and a pixel electrode PE is formed on the light receiving layer 32 (side of the display surface 11).

The counter electrode FE and the pixel electrode PE are made of a transparent electrode material. The counter electrode FE is disposed in such a size as to be common to pixels. The pixel electrode PE is separated in each pixel. The pixel electrode PE in particular has a large number of slits that are long in the vertical direction.

A first alignment film 34 is formed covering the surface of the pixel electrode PE and the underlying insulating film 33A.

A color filter 35 as a light reception anisotropy imparting section, a planarizing film 35A for planarizing the color filter 35, and a second alignment film 36 are formed on one surface (back surface side) of the counter substrate 31.

The TFT substrate 30 is laminated to the counter substrate 31 so as to form an internal space via a spacer (not shown). At this time, the two substrates are laminated to each other such that a surface of the TFT substrate 30 having the light receiving layer 32, the display electrode layer 33, and the first alignment film 34 formed therein is opposed to a surface of the counter substrate 31 having the color filter 35 and the second alignment film 36 formed therein.

A liquid crystal is injected from a part where the spacer is not formed into the internal space between the two substrates. When the liquid crystal injecting part is thereafter closed, the TFT substrate 30, the counter substrate 31, and the spacer seals in the liquid crystal. Thereby a liquid crystal layer 37 is formed. Because the liquid crystal layer 37 adjoins the first alignment film 34 and the second alignment film 36, the direction of alignment of liquid crystal molecules is determined by rubbing directions of the alignment films.

The pixel electrode PE of each pixel and the counter electrode FE common to the pixels are disposed so as to be adjacent to the thus formed liquid crystal layer 37 in a direction of layer thickness. The two kinds of electrodes are to apply voltage to the liquid crystal layer 37. There are a case where the two electrodes are disposed with the liquid crystal layer 37 interposed between the two electrodes (vertical direction driving mode) and a case where the two electrodes are disposed in two layers on the side of the TFT substrate 30 (horizontal direction driving mode). FIG. 11B represents the latter case of the horizontal direction driving mode.

In this case, the pixel electrode PE and the counter electrode FE are insulated and separated from each other, and the counter electrode FE on a lower layer side produces an electric effect on the liquid crystal from intervals of the pattern of the pixel electrode PE adjoining the liquid crystal layer 37 on an upper layer side. Thus, an electric field in the horizontal direction driving mode is in the horizontal direction. On the other hand, when the two electrodes are disposed so as to sandwich the liquid crystal layer 37 from the direction of thickness of the liquid crystal layer 37, the electric field is in the vertical direction (direction of thickness).

Irrespective of driving mode specifications to which the electrodes are disposed, the two electrodes can drive voltage for the liquid crystal layer 37 in the form of a matrix. The liquid crystal layer 37 thus functions as a functional layer (light modulating layer) that optically modulates the transmission thereof. The liquid crystal layer 37 makes gradation display according to the magnitude of the applied voltage.

A second polarizing plate 50 forming a pair with the first polarizing plate 40 disposed between the backlight 20 and the TFT substrate 30 is laminated as another optical functional layer to a surface of the counter substrate 31 on the side of the display surface 11.

The display surface 11 side of the second polarizing plate 50 is covered with a protective layer not shown in the figure. The outermost surface of the protective layer forms the display surface 11 allowing visual recognition of an image from the outside.

In the second embodiment, the part of the display region DR of the color filter 35 does not have color selectivity in connection with the adoption of the field sequential system. This is because color selection is made by the backlight 20 sequentially blinking LEDs of respective colors of R, G, and B.

On the other hand, a light shielding section 60 functioning also as a so-called black matrix is disposed in the sensor region (light shielding region) SR of the color filter 35, and two color filter sections 61R and 61B are disposed on both sides in the horizontal direction of the light shielding section 60. The color filter section 61R is a red transmitting filter that mainly transmits a red (R) color component and which cuts off other color components. The color filter section 61B is a blue transmitting filter that mainly transmits a blue (B) color component and which cuts off other color components.

With the constitution of such a color filter 35, the light shielding section 60 acts to prevent light coming from the front of the optical sensor PS from entering the photodiode PD. On the other hand, at a time of the backlight 20 performing B-light emission, only red (R) reflected light is present as reflected light from a finger or the like, and thus light Lr is made incident from only the right side of the photodiode PD. At a time of the backlight 20 performing B-light emission, only blue (B) reflected light is present, and thus light Lb is made incident from only the left side of the photodiode PD.

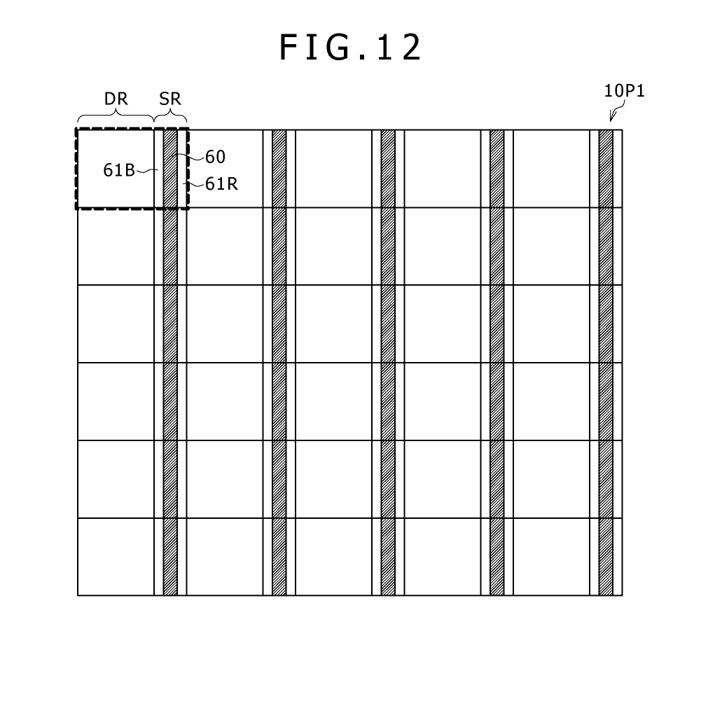

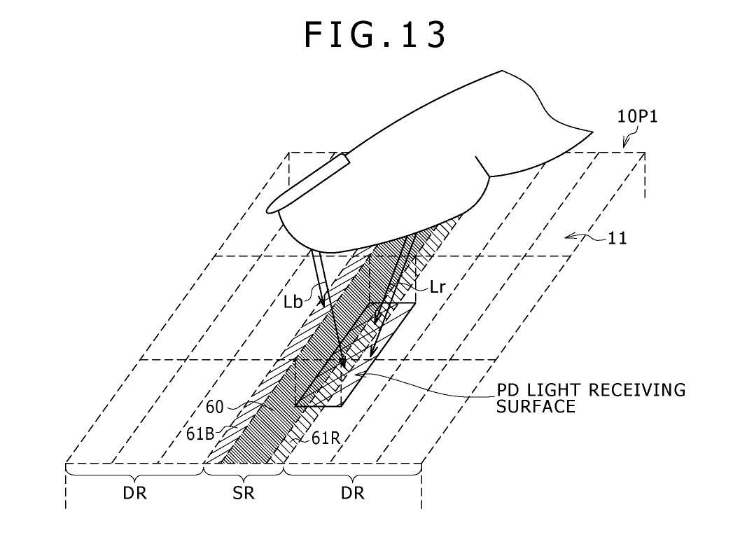

FIG. 12 is a plan view of an arrangement of the display region DR and the sensor region (light shielding region) SR in the display section 10P1. FIG. 13 is a perspective view showing paths of light when a fingertip is brought into proximity to the display surface of a region configuration shown in FIG. 12.

As shown in FIG. 12, the sensor region (light shielding region) SR is formed as lines extending in the column direction (vertical direction) of the display section 10P1, and the display region DR is disposed between the lines. A square region indicated by a thick broken line in FIG. 12 is a pixel unit, and corresponds to a predetermined number of pixels. A pixel unit in the case of RGB three-color display has an area corresponding to three pixels and a black matrix. However, in the field sequential system, the number of colors of color display and the number of pixels of a pixel unit do not necessarily correspond to each other.

When a fingertip is brought into proximity to the display surface of the display section 10P1, red component light Lr made incident obliquely from a right direction passes through the color filter section 61R and reaches the PD light receiving surface, but other color components from the same direction are absorbed by the color filter section 61R. Similarly, blue component light Lb made incident obliquely from a left direction passes through the color filter section 61B and reaches the PD light receiving surface, but other color components from the same direction are absorbed by the color filter section 61B.

A first detection image P1 (see FIGS. 4A1 to 6B), for example, is constructed of a set of sensor outputs output from photodiodes PD when receiving the red component light Lr. In addition, a second detection image P2 (see FIGS. 4A1 to 6B), for example, is constructed of a set of sensor outputs output from the photodiodes PD when receiving the blue component light Lb.

[Operation of Display Device (Including Object Proximity Distance Measuring Method)]

Detailed description will next be made of operation of the display device 10 which operation includes a procedure for obtaining a first detection image P1 and a second detection image P2 and a procedure for height detection.

Description will first be made of a basic operation of the display device 10, that is, an operation of displaying an image and an operation of picking up an image of an object. Because the display device 10 in this case assumes the configuration of FIG. 7, description will be made including even an example in which height information after detection is used by application software.

In the display device 10 of FIG. 7, the display drive circuit 1100 generates a driving signal for display on the basis of display data supplied from the application program executing section 1400. This driving signal effects line-sequential display driving of the I/O display panel 10P, so that an image is displayed.

In addition, at this time, the backlight 20 is also driven by the display drive circuit 1100, and thereby an operation of turning on and turning off the backlight 20 in synchronism with the I/O display panel 10P is performed.

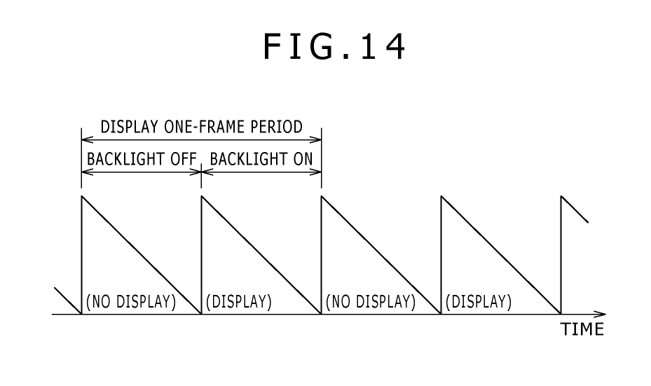

Relation between the operation of turning on or off the backlight 20 and a display state of the I/O display panel 10P will be described in the following with reference to FIG. 14.

First, when image display is made in frame cycles of 1/60 of a second, for example, the backlight 20 is quenched (set in an off state) and thus display is not made in a first half period of each ⅓ frame period (period of 1/360 of a second). On the other hand, in a second half period of each ⅓ frame period of the detecting device, the backlight 20 illuminates (is set in an on state), a display signal is supplied to each pixel, and an image for the frame period is displayed.

Such a ⅓ frame period ( 1/120 of a second) is repeated three times for the respective colors of R, G, and B, whereby an image display for one frame is made.

Thus, the first half period of each ⅓ frame period is a light absence period in which display light is not emitted from the I/O display panel 10P, while the second half period of each ⅓ frame period is a light presence period in which display light is emitted from the I/O display panel 10P.

In this case, when there is an object (for example a fingertip or the like) in contact with or in proximity to the I/O display panel 10P, line-sequential light reception driving by the light reception drive circuit 1200 makes the light receiving element of each pixel in the I/O display panel 10P pick up an image of the object. As a result of the image pickup, a received light signal from each light receiving element is supplied to the light reception drive circuit 1200. The received light signals of pixels for one frame are accumulated in the light reception drive circuit 1200, and then output as a picked-up image to the image processing section 1300.

Then, the image processing section 1300 performs predetermined image processing (arithmetic processing) to be described below on the basis of the picked-up image to detect information on the object in contact with or in proximity to the I/O display panel 10P (position coordinate data, data on the shape and size of the object, and the like).

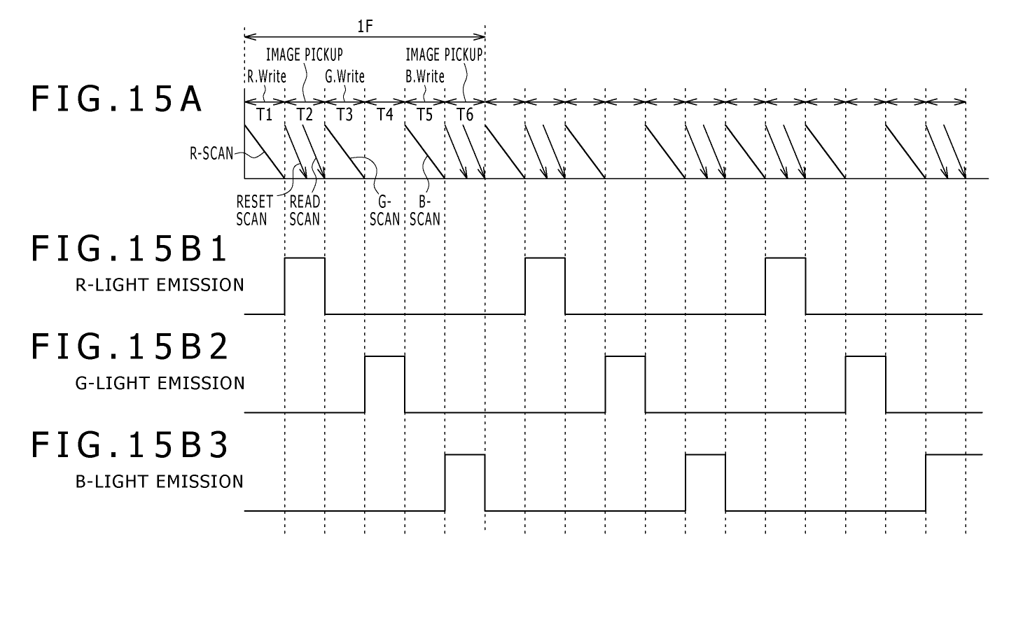

FIGS. 15A to 15B3 are more detailed timing charts. An axis of ordinates in FIG. 15A indicates scan line position, and axes of ordinates in FIGS. 15B1 to 15B3 indicate pulse potential. Axes of abscissas in FIGS. 15A to 15B3 indicate time.

FIG. 15A schematically shows a writing operation period and scan operation. FIG. 15B1 shows an R-light emission period. FIG. 15B2 shows a G-light emission period. FIG. 15B3 shows a B-light emission period.

As with FIG. 14, FIGS. 15B1 to 15B3 show that a non-emission period (backlight off) and an emission period (backlight on) are repeated in short cycles ( 1/360 of a second).

A first backlight-off period T1 in one frame period is an R-writing period, in which the display scanning line DSCN (FIG. 9) is controlled by the display V-driver 2300 (FIG. 8) and thereby an R-display signal is set in the pixel electrode PE via the access transistor AT. In a next period T2, the backlight is on, and thereby B-light emission display is made.

This operation is similarly repeated for G-light emission display and B-light emission display in combinations of periods T3 and T4 and periods T5 and T6.

In the present embodiment, the image pickup operation of optical sensors is performed in the periods T2 and T6 corresponding to the time of R-light emission and B-light emission among the periods T2, T4, and T6 corresponding to the on state of the backlight. In each of the periods T2 and T6, a reset scan that scans the reset line RSTL in FIG. 9 on a line-sequential basis is performed, and a read scan that scans the read control line RCL on a line-sequential basis is performed with a delay. The time of each scan for one screen is a half time of the period T2 or T6. When the reset scan for one screen is ended, the read scan is started simultaneously. A delay time between the reset scan and the read scan is a charge accumulating time (image pickup time). When operations of charge accumulation (image pickup) and discharge (read) are performed for one screen with a certain delay time, sensor output is read out from a plurality of sensor lines SL to the sensor readout H-driver 6SRH in FIG. 10 in time series.

A concrete method of recognizing a first detection image P1 and a second detection image P2 by the sensor readout H-driver 6SRH and determining a height from positional displacement between the first detection image P1 and the second detection image P2 has been described with reference to FIGS. 4A1 to 4B2 and FIGS. 6A and 6B in the first embodiment, and therefore description of the concrete method will be omitted in the following.

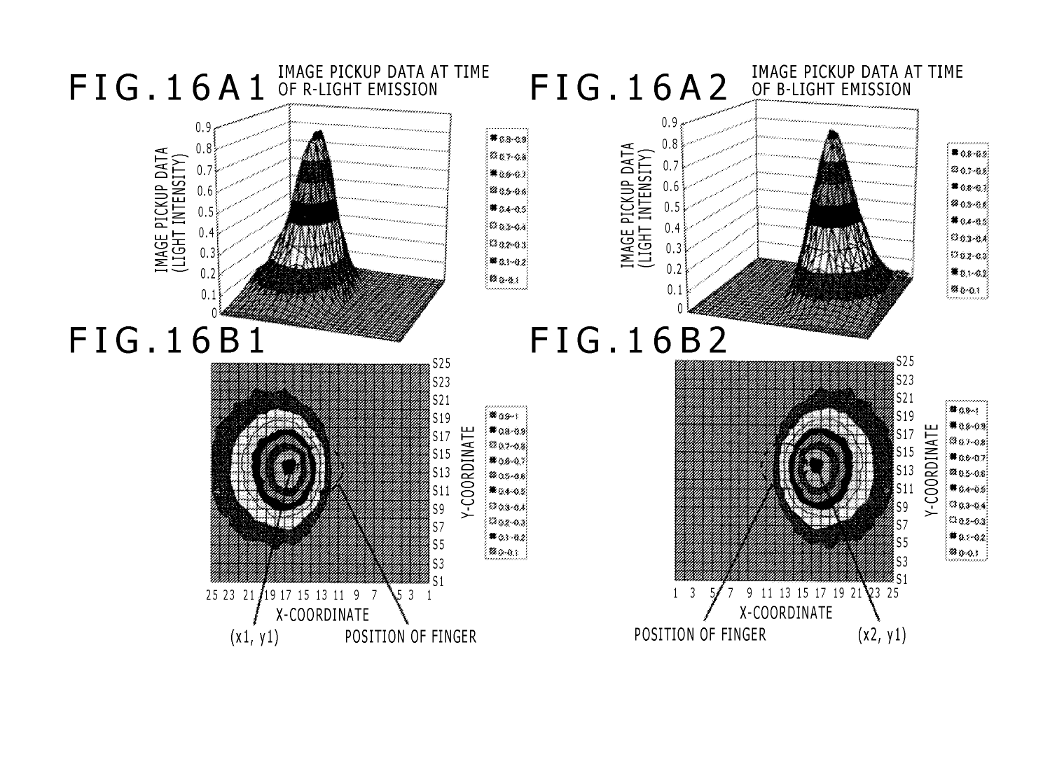

FIGS. 16A1 to 16B2 show a result of analysis of image pickup data. FIGS. 16A1 and 16B1 are diagrams showing stereoscopic display and planar display of image pickup data at a time of R-light emission. FIGS. 16A2 and 16B2 are diagrams showing stereoscopic display and planar display of image pickup data at a time of B-light emission.

The position of a finger is the center of the image pickup data. It is shown that the peak positions of respective pieces of image pickup data are displaced to a left and a right from the position of the finger. Suppose that the coordinates of the peak position at the time of the R-light emission are (x1, y1), and that the coordinates of the peak position at the time of the B-light emission are (x2, y1).

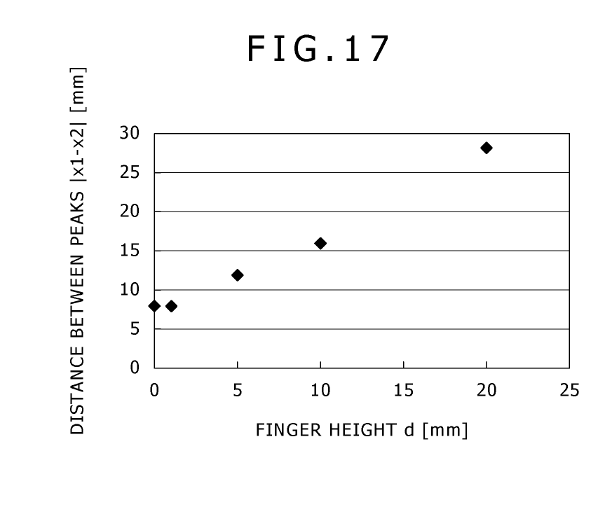

FIG. 17 is a graph where an axis of abscissas indicates finger height (distance between the detected object and the light receiving surface) and an axis of ordinates indicates distance |x1−x2| between the peaks in the x-direction.

The distance |x1−x2| between the peaks monotonically increases with respect to the finger height d. Thus, when sensing is to be performed at a certain finger height, whether a detected object has come to the certain height can be determined by setting a threshold value for the distance between the peaks.

For example, when sensing is desired to be performed at the finger height d=10 [mm], whether an object to be detected is present or not can be determined by supposing that:

a “finger is present” when the distance |x1−x2| between the peaks >16, and

a “finger is not present” when the distance |x1−x2| between the peaks ≦16.

In addition, because the finger height d itself can be determined accurately, information on the height can be applied to operations of various application software.

The detection of the finger height d as described above, the determination of whether an object to be detected is present or not using the detection of the finger height d, and position determination are performed by the image processing section 1300 in FIG. 7. The application to operations of application software is performed by the application program executing section 1400 on the basis of a sensing result from the image processing section 1300. A result of the application is fed back to display data as required.

The present embodiment can accurately detect the distance (height) from the sensor light receiving surface to the detected object.

In addition, the optical sensors PS (light receiving layer 32 in FIG. 11B) and the light reception anisotropy imparting section 4 (color filter 35 in FIG. 11B) can be produced by the same process as that of the display device 10. The display device 10 according to the present embodiment thus eliminates a need for external members required for a capacitance type and the like. Therefore cost can be reduced.

Further, by adopting a time division system, image pickup data of very high resolution can be obtained, and the distance from the light receiving surface to the detected object can be calculated with high accuracy.

The second embodiment is susceptible of the following modifications.

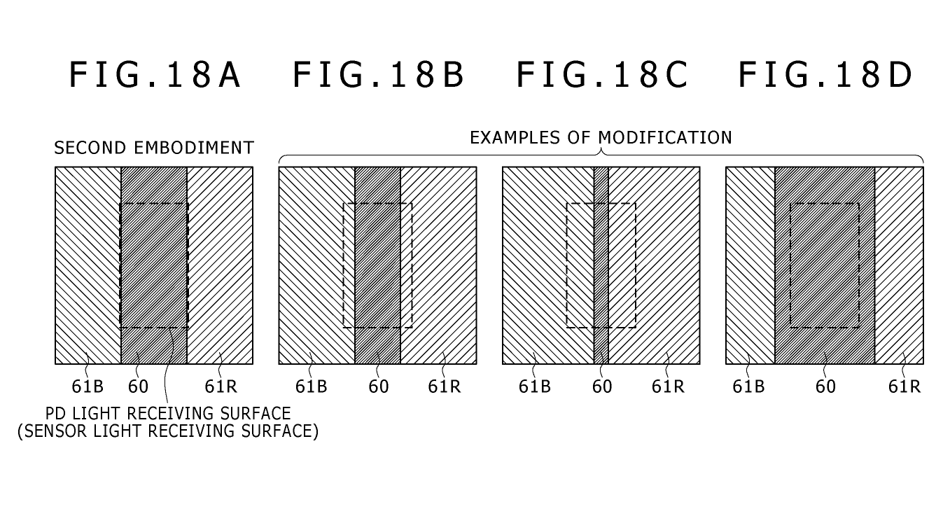

The examples shown in FIGS. 11A and 11B and 12 have a structure that blocks light directly above the sensor light receiving surface. However, as shown in FIGS. 18B and 18C, for example, even when the light shielding section 60 is smaller than the sensor light receiving surface, the structures of FIGS. 18B and 18C can be adopted as long as the light reception anisotropy of the optical sensors PS is retained. Conversely, a structure in which the light shielding section 60 is larger than the sensor light receiving surface can be adopted as long as the light reception anisotropy of the optical sensors PS is retained.

In addition, the light shielding section for shielding the sensor light receiving surface from light does not necessarily need to be created on the side of the counter substrate 31. The light shielding section may be created on the side of the TFT substrate 30. However, a separation for receiving oblique light becomes necessary between the sensor light receiving surface and the light shielding section.

The detected light may be visible light or invisible light (ultraviolet rays or infrared rays). However, it is desirable to use invisible light for detected light when a system not dependent on display images is intended. When the detected light is invisible light, LEDs illuminating for an image pickup period at least and emitting invisible light need to be added to the backlight 20, or a backlight including the LEDs needs to be provided.

Further, a liquid crystal mode may be any of a TN mode, a VA mode, an IPS mode, an FFS mode, an ECB mode and the like.

### 3. Third Embodiment

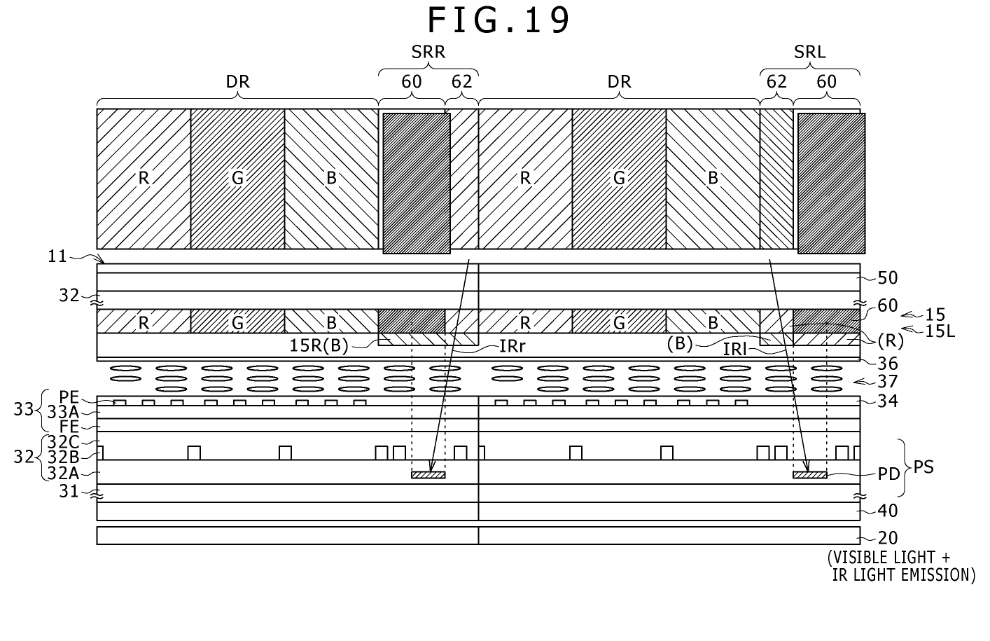

The present embodiment is illustrated in FIGS. 19 to 21 in relation to a (liquid crystal) display device employing a space division system.

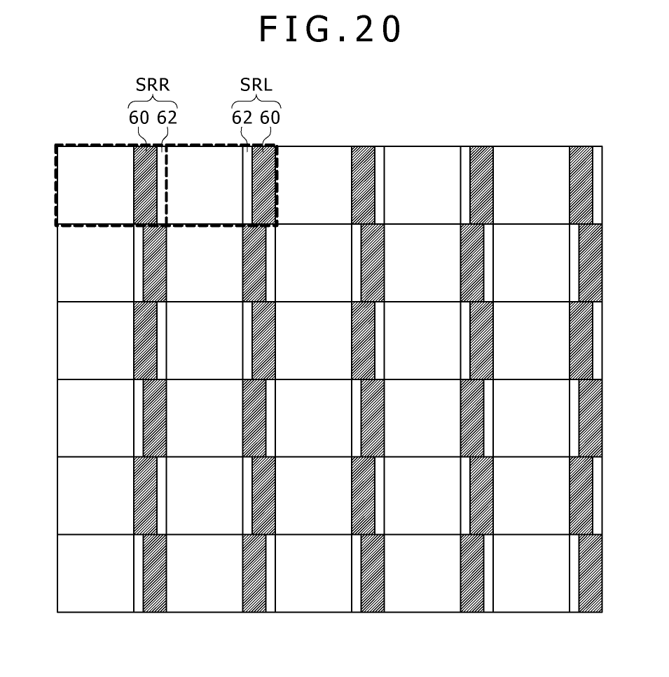

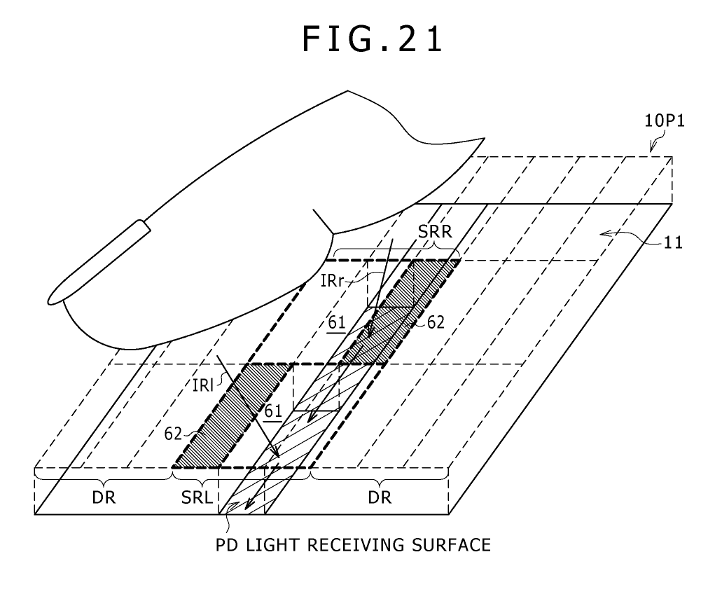

FIG. 19 corresponds to FIGS. 11A and 11B related to the second embodiment, FIG. 20 corresponds to FIG. 12, and FIG. 21 corresponds to FIG. 13. In the following, description will be made of differences of FIGS. 19 to 21 from FIGS. 11 to 13, and description of constitutions identified by the same reference numerals will be omitted. Basics of the detecting method described with reference to FIGS. 7 to 10 and in the first embodiment are also applied in the present embodiment.

FIG. 19 is a sectional view and a plan view of two pixel units adjacent to each other in a horizontal direction.

In the third embodiment, as in the second embodiment, a light receiving layer 32 and a display electrode layer 33 are formed in a TFT substrate 30 by a same process, and a color filter 15 is formed in a counter substrate 31. Photodiodes PD are arranged in the form of a matrix in the light receiving layer 32, thereby forming an optical sensor array 3 (see FIGS. 1A and 1B).

The space division system has two kinds of optical sensors PS.

The kinds of optical sensors mean that light transmission characteristics of the color filter 15 differ. That is, light reception anisotropy is imparted to the photodiodes PD by making the light transmission characteristics of the color filter 15 differ, and the optical sensor array is spatially separated in this sense.

Specifically, a light shielding section 60 blocks light directly above the light receiving surface of each photodiode PD of both of two optical sensors adjacent to each other in the horizontal direction. However, the color filter 15 has a structure such that the sensor region of one optical sensor PS has an opening for a specific wavelength component such as an infrared light component IR on the right side of the light shielding section 60 and conversely the sensor region of another optical sensor PS has an opening for a specific wavelength component on the left side of the light shielding section 60.

The sensor region having the right side opening will be referred to as a right anisotropy sensor region SRR, and the sensor region having the left side opening will be referred to as a left anisotropy sensor region SRL.

Then, as shown in FIG. 20, the pixel units (square regions indicated by thick broken lines) respectively including the right anisotropy sensor region SRR and the left anisotropy sensor region SRL are arranged in a checkered matrix arrangement as viewed from a display surface.

The arrangement method is not limited to the checkered form, but a striped arrangement may be used.

The second embodiment has an inconvenience in that when visible light is used for detected light and a display image is black display, there is no reflected light from an object to be detected and therefore the object to be detected cannot be sensed.

The third embodiment accordingly employs a system not dependent on display images by using infrared light IR of infrared rays (wavelength λ=850 [nm]) for detected light. However, a similar system can be constructed even with visible light.

When detected light is infrared light IR, the parts represented as the openings of the right anisotropy sensor region SRR and the left anisotropy sensor region SRL, need to be an IR transmitting section 62 provided with an IR selective transmission characteristic.

There are various methods for forming the IR transmitting section 62. In this case, however, as shown in FIG. 19, the IR transmitting section 62 is realized by a two-layer superposition structure in which a red (R) transmitting filter layer is superposed on a red (R) color filter section.

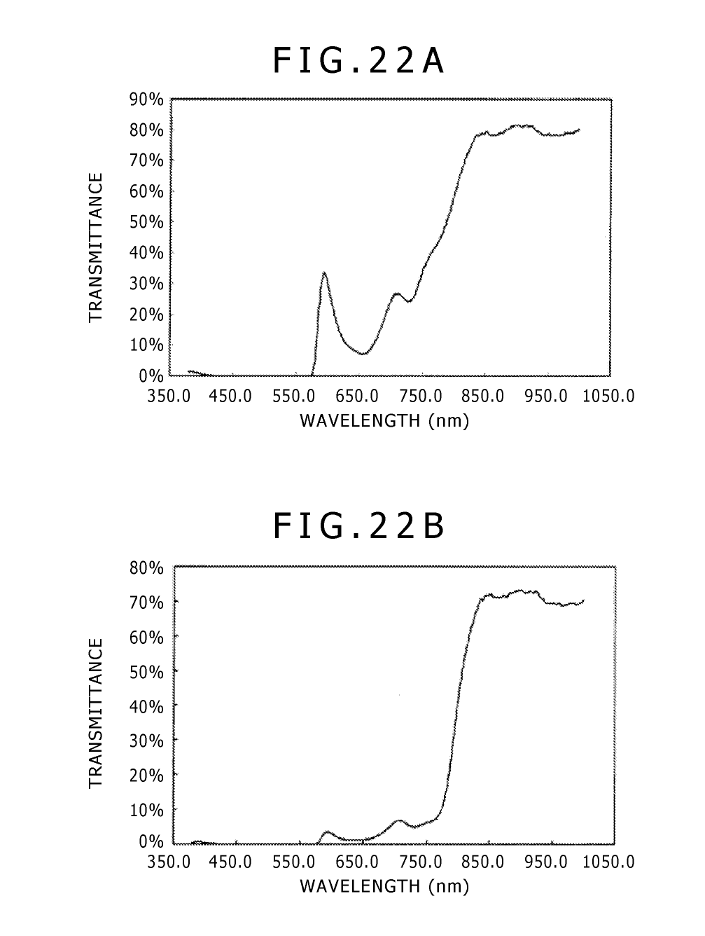

FIG. 22A shows a transmission spectrum of a filter having a two-layer superposition structure of R and B (RB filter).

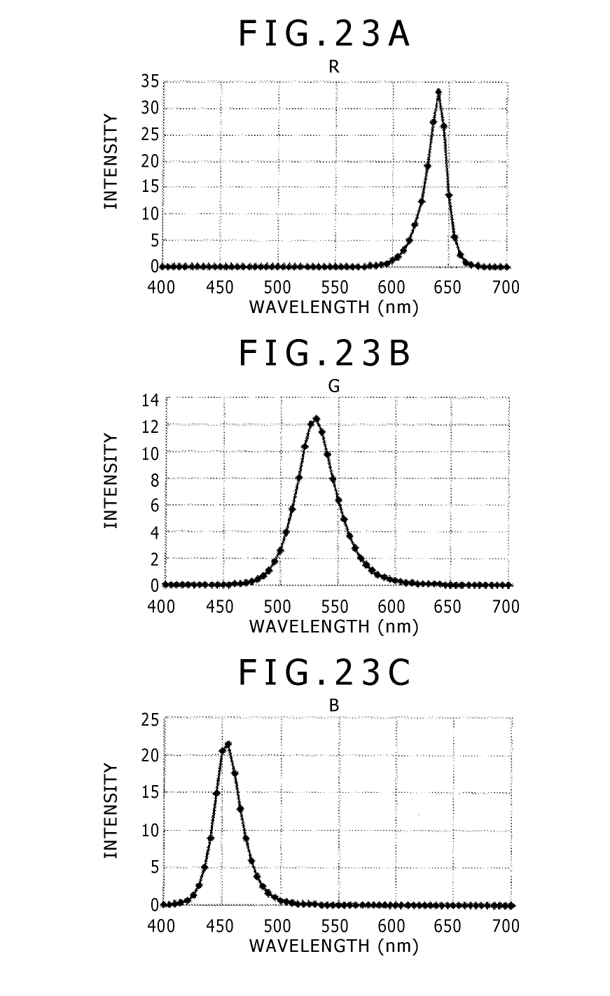

A reference to the wavelength ranges of respective colors in FIGS. 23A to 23C shows that the RB filter of FIG. 22A blocks visible light but favorably transmits infrared rays (wavelength λ=850 [nm]). Thereby a system not dependent on display images can be constructed.

The IR transmitting section 62 can be a filter of a three-layer superposition structure of R, G, and B (RGB filter).

FIG. 22B shows the transmission spectrum of the RGB filter.

This spectrum shows that the RGB filter has a greater effect of blocking visible light than the RB filter and can correspondingly improve detection accuracy.

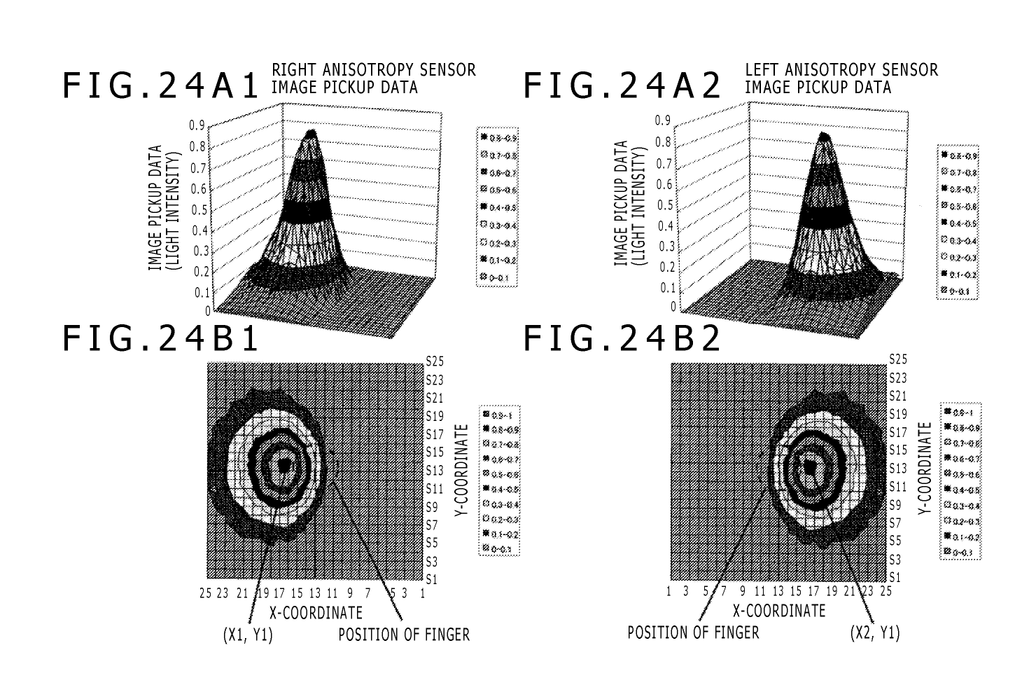

FIGS. 24A1 to 24B2 show the image pickup data of a right anisotropy sensor receiving IR light transmitted by the right anisotropy sensor region SRR and the image pickup data of a left anisotropy sensor receiving IR light transmitted by the left anisotropy sensor region SRL.

The position of a finger is the center of the image pickup data. It is shown that the peak positions of the respective pieces of image pickup data are displaced to a left and a right from the position of the finger. Suppose that the coordinates of the peak position of the image pickup data output from the right anisotropy sensor are (X1, Y1), and that the coordinates of the peak position of the image pickup data output from the left anisotropy sensor are (X2, Y1).

A graph similar to FIGS. 16A1 to 16B2 can be obtained by calculating an X-coordinate difference |X1−X2| between the peak positions.

When sensing is to be performed at a finger height similar to that of the first embodiment and the second embodiment, whether an object to be detected is present or not at a certain height can be determined with the threshold value of the distance between the peaks as a reference. In addition, as in the second embodiment, position information including height information can be applied to operations of application software.

Incidentally, the third embodiment preferably performs a display scan and an image pickup scan in parallel with each other in one field without performing time-division LED blinking or control of scan operation in synchronism with the time-division LED blinking. Accordingly, the backlight 20 is changed so as to have for example a white LED and an IR light LED as a light source, or a white light source and an IR light source are preferably separated and used in two backlights.

As shown in FIG. 19, the pixel unit has a total area of three pixels and a sensor region in a case of RGB three-color mixture, and has an area larger by an area of one pixel in a case of four-color mixture.

As with the second embodiment, the third embodiment provides advantages of being able to detect the height of a detected object accurately and eliminating a need for external members required for a capacitance type and the like, so that cost can be reduced.

Further, the space division system eliminates a need for a special three-color LED backlight, and can thus be realized at low cost. In addition, the space division system can lower display clock frequency for one screen as compared with time division.

The third embodiment is susceptible of the following modifications.

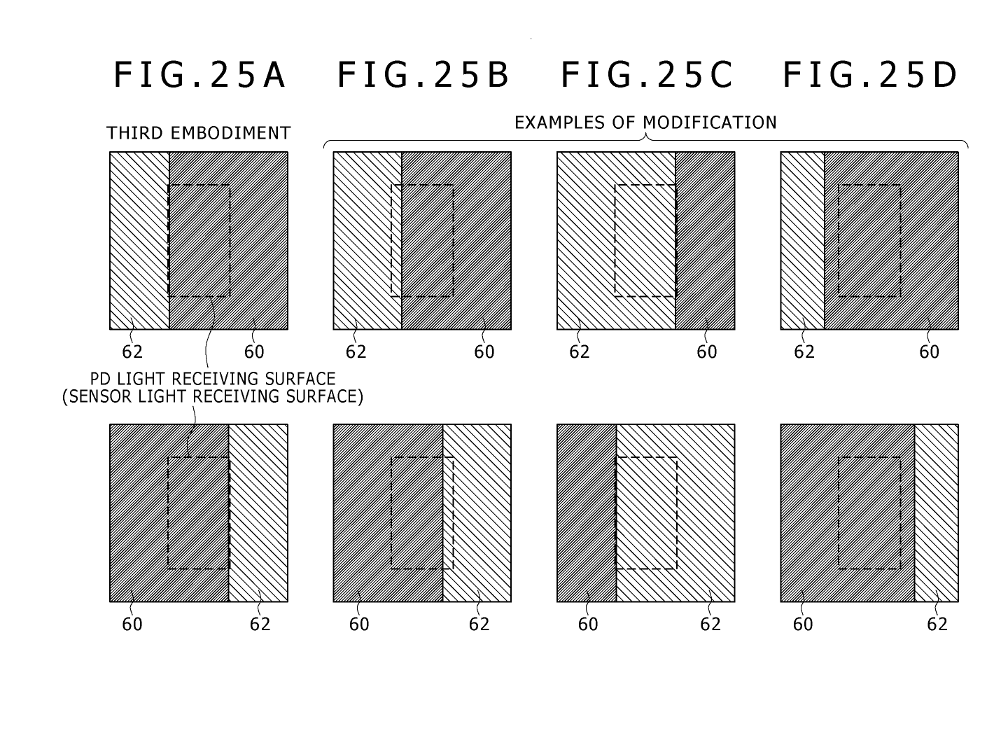

The examples shown in FIGS. 19 to 21 have a structure that blocks light directly above the sensor light receiving surface. However, as shown in FIGS. 25B to 25D, for example, the sensor light receiving surface may be covered more completely, or a part or the whole of the sensor light receiving surface does not need to be covered. However, these examples of modification are conditioned on the retention of light reception anisotropy of the optical sensors PS.

In addition, as in the second embodiment, the light shielding section for shielding the sensor light receiving surface from light does not necessarily need to be created on the side of the counter substrate 31. Further, a liquid crystal mode may be any of a TN mode, a VA mode, an IPS mode, an FFS mode, an ECB mode and the like.

Supposing that visible light is detected in the case of a space division type, in particular, the present invention may be applied to a reflective type liquid crystal display device that picks up an image of the shadow of a detected object. In this case, the backlight 20 including a special light source such as an IR light source is rendered unnecessary.

### 4. Fourth Embodiment

### Light Reception Anisotropy by Lens Array

The impartation of light reception anisotropy by a lens array will next be described with reference to drawings. This fourth embodiment represents a kind of space division system, and represents a constitution adoptable in place of the IR transmitting section 62 provided in the color filter 15 in the third embodiment.

In an example of FIG. 26, an array of cylindrical lenses is formed on a second polarizing plate 50, for example. The cylindrical lenses have a semicylindrical section, and are thus able to efficiently condense light obliquely incident from a right on right sensors arranged on a left side. Similarly, the cylindrical lenses can efficiently condense light obliquely incident from a left on left sensors arranged on a right side.

In the fourth embodiment, photodiodes PD are arranged so as to be adjacent to each other in pairs, and light reception anisotropy is imparted by allowing the photodiodes PD to receive left and right oblique light. Thus, in the present embodiment, light reception anisotropy is effected by cooperation between the lens array as a light reception anisotropy imparting section 4 and an optical sensor array having photodiodes PD in pairs as an optical sensor array 3.

For example, an image obtained by right sensors (PD) is set as a first detection image P1, an image obtained by left sensors (PD) is set as a second detection image P2, and a height is detected from a difference between peaks or barycenters of the first detection image P1 and the second detection image P2.

Incidentally, in the display device 10, the light reception anisotropy imparting section 4 is desirably realized by a light shielding filter or a color filter from a viewpoint of cost and from a viewpoint of reducing the thickness of the display device 10. A color filter in particular is provided also to a display device 10 to which the present invention is not applied for a color arrangement of pixels, and it suffices only to modify the existing color filter to impart light reception anisotropy when the present invention is applied. It is thus most desirable to realize the light reception anisotropy imparting section 4 by a color filter from a viewpoint of cost reduction when the present invention is applied to a display device 10.

### 5. Fifth Embodiment

Display devices 10 to which the present invention is applied may employ any display methods other than liquid crystal display, such for example as systems of organic EL, inorganic EL and electronic paper.

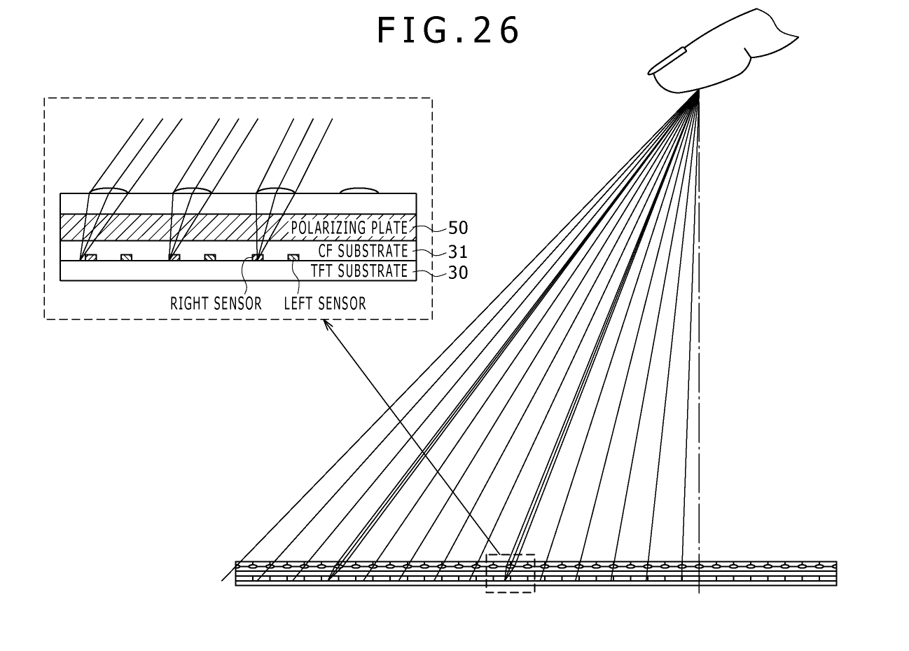

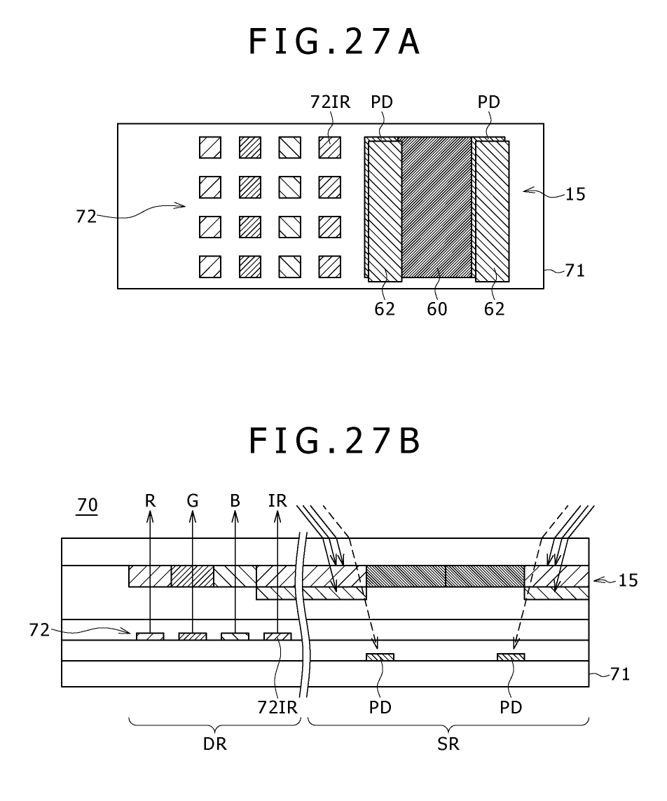

FIGS. 27A and 27B are diagrams of a layout when the present invention is applied to organic EL as an example.

An organic EL display device 70 has an organic EL film emitting light of R, G, and B by itself within the laminated structure of a substrate 71.

An organic laminated film 721R having a light emission characteristic of emitting an infrared light component IR or including a high proportion of the infrared light component IR is formed in the organic EL film, and the organic laminated film 721R is set as an IR light source.

In the present embodiment, light reception anisotropy is imparted to photodiodes PD by a color filter 15 similar to that of the third embodiment.

Incidentally, the above description has been made of a space division system using infrared light IR. However, the IR light source does not need to be present, or the present embodiment can be realized also by a time division system.

### 6. Sixth Embodiment

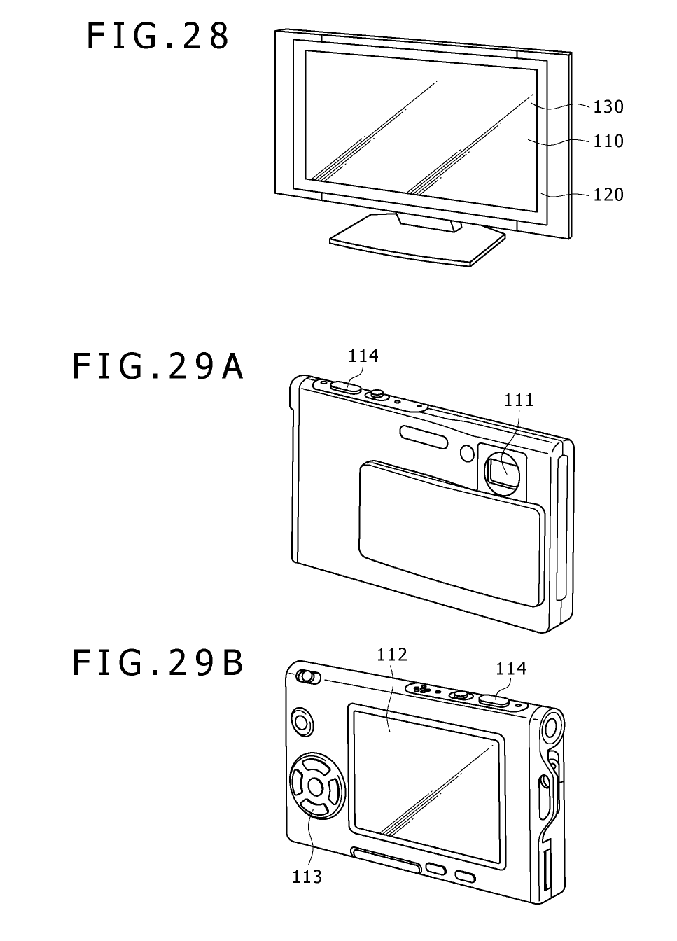

The display device according to the present embodiment described above is applicable to display devices of electronic devices in all fields that display a video signal input thereto or a video signal generated therein as an image or video, such as various electronic devices shown in FIGS. 28 to 32G, for example a digital camera, a notebook personal computer, a portable terminal device such as a portable telephone, and a video camera. An example of electronic devices to which the present embodiment is applied will be described in the following.

FIG. 28 is a perspective view of a television set to which the present invention is applied.

The television set according to the present example of application includes a video display screen part 110 composed of a front panel 120, a filter glass 130 and the like. The display devices according to the second to fifth embodiments can be used as the video display screen part 110.

FIGS. 29A and 29B are perspective views of a digital camera to which the present invention is applied. FIG. 29A is a perspective view of the digital camera as viewed from a front side, and FIG. 29B is a perspective view of the digital camera as viewed from a back side.

The digital camera according to the present example of application includes a light emitting part 111 for flashlight, a display part 112, a menu switch 113, a shutter button 114, and the like. The display devices according to the second to fifth embodiments can be used as the display part 112.

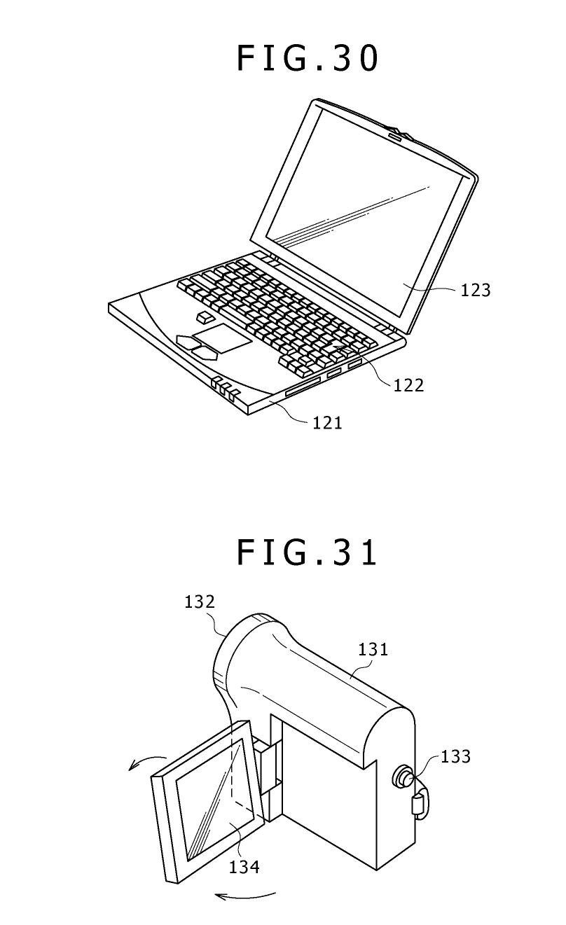

FIG. 30 is a perspective view of a notebook personal computer to which the present invention is applied.

The notebook personal computer according to the present example of application includes a keyboard 122 operated to input characters and the like, a display part 123 for displaying an image, and the like in a main unit 121. The display devices according to the second to fifth embodiments can be used as the display part 123.

FIG. 31 is a perspective view of a video camera to which the present invention is applied.

The video camera according to the present example of application includes a main unit 131, a lens 132 for taking a subject in a side surface facing frontward, a start/stop switch 133 at a time of picture taking, a display part 134, and the like. The display device according to the present embodiment can be used as the display part 134.

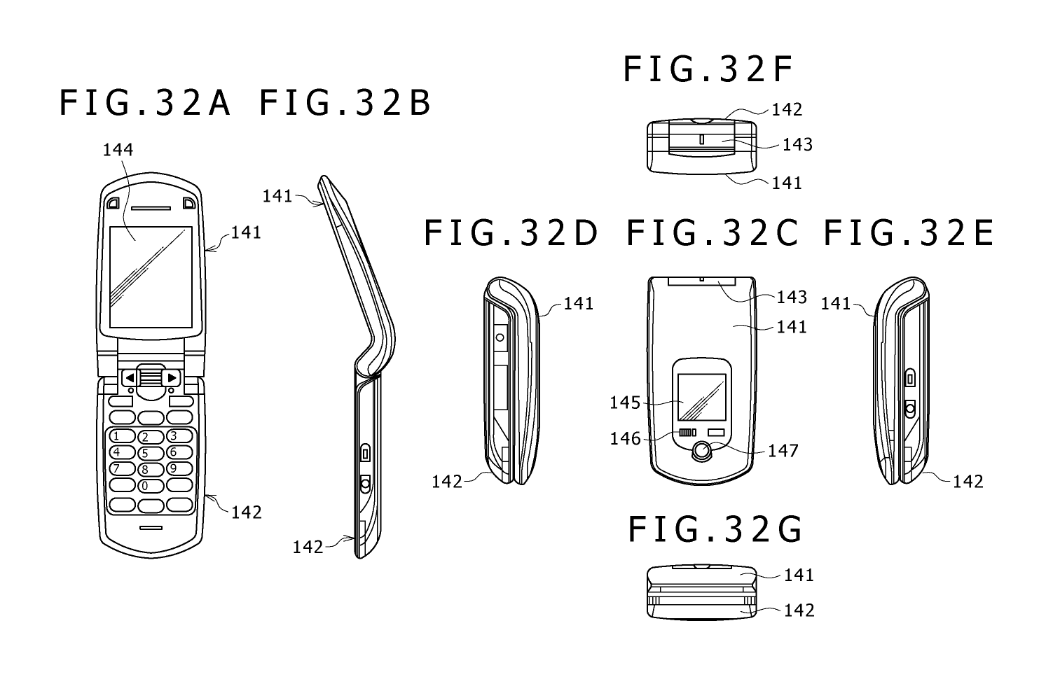

FIGS. 32A, 32B, 32C, 32D, 32E, 32F, and 32G are diagrams showing a portable terminal device, for example a portable telephone to which the present invention is applied. FIG. 32A is a front view of the portable telephone in an opened state, FIG. 32B is a side view of the portable telephone in the opened state, FIG. 32C is a front view of the portable telephone in a closed state, FIG. 32D is a left side view, FIG. 32E is a right side view, FIG. 32F is a top view, and FIG. 32G is a bottom view.

The portable telephone according to the present example of application includes an upper side casing 141, a lower side casing 142, a coupling part (a hinge part in this case) 143, a display 144, a sub-display 145, a picture light 146, a camera 147, and the like. The display devices according to the second to fifth embodiments can be used as the display 144 and the sub-display 145.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A detecting device comprising:
an optical sensor array having light reception anisotropy;
a detection driving section configured to drive said optical sensor array, pick up an image of a detected object, and generate a plurality of different detection images on a basis of said light reception anisotropy; and
a height detecting section configured to receive said plurality of detection images input to the height detecting section, and detect a distance from a sensor light receiving surface of said optical sensor array to said detected object on a basis of magnitude of a positional displacement occurring due to difference in said light reception anisotropy in image parts corresponding to one of a shadow and a reflection of said detected object, the image parts being included in the plurality of input detection images.

2. The detecting device according to claim 1, further comprising
a light reception anisotropy imparting section configured to impart different light reception anisotropies within a set of a plurality of optical sensors adjacent to each other in said optical sensor array, the light reception anisotropy imparting section being disposed on a side of said optical sensor array on which side said detected object approaches.

3. The detecting device according to claim 2, wherein
said optical sensor array is formed by two-dimensionally arranging a plurality of optical sensors to which said light reception anisotropy is imparted by producing wavelength dependence in amounts of received light incident from different directions when the light transmitted by said light reception anisotropy imparting section is received, and
said detection driving section irradiates said detected object with a plurality of pieces of light respectively having different wavelength ranges from each other on a time division basis, performs a plurality of times of image pickup by the light in the different wavelength ranges by controlling each light reception time when reflected light reflected and returned by said detected object is received by said plurality of optical sensors after being transmitted by said light reception anisotropy imparting section in synchronism with the irradiation with said plurality of pieces of light on a time division basis, and generates said plurality of detection images by the plurality of times of image pickup.

4. The detecting device according to claim 3, wherein
a part opposed to a light receiving surface of one of said optical sensors in said light reception anisotropy imparting section has a light shielding section and a pair of wavelength selecting filter sections configured to transmit different wavelength ranges on both sides in one direction of the light shielding section, and light reception anisotropy is imparted to said optical sensor by imparting wavelength selectivity to light incident obliquely from one side in said one direction and light incident obliquely from another side in said one direction.

5. The detecting device according to claim 2, wherein
said light reception anisotropy imparting section is a light shielding filter having a pattern for each optical sensor, the pattern shielding a part or a whole of each sensor light receiving surface of said plurality of optical sensors adjacent to each other from light on a side on which said detected object approaches, at least one of an arrangement and a shape of the pattern being different for said plurality of optical sensors,
a plurality of optical sensor arrangements in which said light reception anisotropy differs according to difference in degree of light shielding exerted by said pattern of said light shielding filter are defined in said optical sensor array, and
said detection driving section drives said optical sensor array, and generates said plurality of detection images different from each other from said plurality of optical sensor arrangements.

6. The detecting device according to claim 2, further comprising
a light irradiating section, wherein
said light reception anisotropy imparting section is a lens array disposed on a light incidence side of said optical sensor array,
a plurality of optical sensor arrangements in which said light reception anisotropy differs are defined in said optical sensor array by arranging said plurality of optical sensors for one lens of said lens array such that optical sensors mainly receiving reflected light reflected by said detected object according to an angle of incidence when said light irradiating section applies light having components in different directions are different within said set, and
said detection driving section drives said optical sensor array, and generates said plurality of detection images different from each other from said plurality of optical sensor arrangements.

7. The detecting device according to claim 1, wherein
said height detecting section identifies said image part corresponding to said detected object in each of said plurality of detection images, determines a peak position of an amount of received light of the identified image part in each of said plurality of detection images, and determines said height by operation from a difference between the peak positions of said amounts of received light in said plurality of detection images.

8. The detecting device according to claim 1, wherein
said height detecting section binarizes each sensor output included in each of said plurality of detection images according to magnitude relation to a threshold value, identifies the image parts corresponding to said detected object from resulting binarized information, calculates respective barycentric positions of the image parts, and determines said height by operation from a difference between the obtained barycentric positions.

9. A display device comprising:
a light modulating section configured to modulate incident light according to an input video signal, and output a generated display image;
a display surface for displaying said display image from said light modulating section;
an optical sensor array having light reception anisotropy;
a detection driving section configured to drive said optical sensor array, pick up an image of a detected object in contact with or in proximity to said display surface, and generate a plurality of different detection images on a basis of said light reception anisotropy; and
a height detecting section configured to receive said plurality of detection images input to the height detecting section, and detect a distance from a sensor light receiving surface of said optical sensor array to said detected object on a basis of magnitude of a positional displacement occurring due to difference in said light reception anisotropy in image parts corresponding to one of a shadow and a reflection of said detected object, the image parts being included in the plurality of input detection images.

10. The display device according to claim 9, wherein
said detection driving section generates said plurality of detection images by image pickup of said detected object in a period in which said light modulating section is not outputting said display image.

11. The display device according to claim 9, wherein
said detection driving section generates said plurality of detection images by image pickup of said detected object by irradiating said detected object with invisible light different from visible light modulated by said light modulating section.

12. The display device according to claim 9, wherein
said light modulating section is disposed between said optical sensor array and said display surface,
a color filter for limiting a wavelength range of transmitted light in each part opposed to said optical sensor in said light modulating section is disposed between said light modulating section and said display surface, and
a light shielding section of said color filter is disposed so as to be opposed to a light receiving surface of the optical sensor, and said light reception anisotropy is imparted to said optical sensor array by making a wavelength range of light transmitted by a color filter part adjacent to the light shielding section different for each optical sensor in at least one direction within a sensor arrangement plane.

13. The display device according to claim 11, wherein
said detection driving section irradiates said detected object with a plurality of pieces of light respectively having different wavelength ranges from each other on a time division basis, performs a plurality of times of image pickup by the light in the different wavelength ranges by controlling each light reception time when reflected light reflected and returned by said detected object is received by said plurality of optical sensors after being transmitted by said color filter in synchronism with the irradiation with said plurality of pieces of light on a time division basis, and generates said plurality of detection images by the plurality of times of image pickup.

14. An object proximity distance measuring method comprising:
driving an optical sensor array having light reception anisotropy, picking up an image of a detected object, and generating a plurality of different detection images on a basis of said light reception anisotropy; and
receiving said plurality of input detection images, and measuring a distance from a sensor light receiving surface of said optical sensor array to said detected object on a basis of magnitude of a positional displacement occurring due to difference in said light reception anisotropy in image parts corresponding to one of a shadow and a reflection of said detected object, the image parts being included in the plurality of input detection images.

15. An object proximity distance measuring method comprising:
picking up an image of a detected object a plurality of times by a combination of optical sensors corresponding to different light reception anisotropies from a plurality of optical sensors within an optical sensor array having the light reception anisotropies; and
receiving a plurality of input detection images obtained by said plurality of times of image pickup, and measuring a distance from a sensor light receiving surface of the optical sensor array to said detected object on a basis of magnitude of a positional displacement occurring due to difference in said light reception anisotropies in image parts corresponding to one of a shadow and a reflection of said detected object, the image parts being included in the plurality of input detection images.

16. The object proximity distance measuring method according to claim 15, wherein
each of the plurality of optical sensors within said optical sensor array is an optical sensor provided with said light reception anisotropy by imparting wavelength dependence to amounts of received light incident from different directions, and
in the step of picking up an image of said detected object, said detected object is irradiated with a plurality of pieces of light having respective wavelength ranges different from each other on a time division basis, and light reception times of said plurality of optical sensors are controlled on a time division basis in synchronism with the irradiation with said plurality of pieces of light such that reflected light reflected and returned when said detected object is irradiated with light in a corresponding wavelength range can be received by an optical sensor having a corresponding light reception sensitivity peak.
